(19) United States
(12) Patent Application Publication
(10) Pub. No.: US 2005/0129997 A1
(43) Pub. Date: Jun. 16, 2005

(54) Hydrogen generator, method of operating hydrogen generator, and fuel cell system

(75) Inventors: Akira Maenishi, Osaka (JP); Kunihiro Ukai, Nara (JP); Tomonori Asou, Nara (JP); Yuji Mukai, Osaka (JP); Yoshio Tamura, Nara (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 10/989,556

(22) Filed: Nov. 17, 2004

(30) Foreign Application Priority Data
Nov. 20, 2003 (JP) 2003-391317

(51) Int. Cl. H01M 8/04; H01M 8/06; C01B 3/38

(52) U.S. Cl. 429/20; 429/17; 429/24; 429/26; 423/652

(57) ABSTRACT

A hydrogen generator comprises a controller configured to control supply of a material from a material supply portion and supply of water from a water supply portion. The controller monitors a temperature of a water evaporator and a temperature of a reforming catalyst layer, and based on this monitored result, the controller properly controls water supply from the water supply portion to the water evaporator.

### BACKGROUND OF THE INVENTION

### FIELD OF THE INVENTION

The present invention relates to a hydrogen generator configured to generate a hydrogen-rich gas through steam reforming reaction using hydrocarbon based material such as a natural gas, LPG, gasoline, naphtha, coal oil, or methanol, as a major material, and a method of operating the hydrogen generator. More particularly, the present invention relates to a hydrogen generator configured to generate hydrogen supplied to hydrogen consumption equipment such as a fuel cell, and a method of operating the hydrogen generator in a start operation.

### DESCRIPTION OF THE INVENTION

In a hydrogen generator, a material containing an organic compound comprised of at least carbon atoms and hydrogen atoms is typically steam-reformed in a reformer having a reforming catalyst layer. Through such steam reforming reaction, a hydrogen-rich gas (hydrogen) is generated as a reformed gas. If water is directly supplied to the reforming catalyst layer in the reforming reaction, the reforming catalyst layer or gas passages formed downstream of the reforming catalyst layer may possibly be clogged with water. Therefore, the water is supplied in the form of steam to the reforming catalyst layer.

One prior art example of the hydrogen generator is disclosed in Japanese Laid-Open Patent Application Publication No. 2001-302207, in which a temperature of a reforming catalyst in a reformer is detected during a preheating operation in a start operation of the hydrogen generator, and water starts to be supplied from a water supply portion to the reformer when the detected temperature reaches a predetermined value. Another prior art example of the hydrogen generator is disclosed in Japanese Laid-Open Patent Application Publication No. 2002-252604, in which flow direction of water changes from axially downward to axially upward while flowing through a water supply passage fluidically communicating with a reforming catalyst layer of a reformer, and a water evaporator is formed at a bottom portion of the passage. In such a construction, the supplied water is evaporated into steam in the water evaporator and supplied to the reforming catalyst layer, and water unevaporated in the water evaporator is reserved in the bottom portion.

In the hydrogen generator, if the amount of the steam supplied to the reforming catalyst layer heated to a high temperature is insufficient relative to the amount of the supplied material, only the material, which has a high temperature, flows within the catalyst layer or gas passages in the reformer. In the above hydrogen generator in which the water evaporator is formed at the bottom portion of the water supply passage in which the flow direction of water changes from axially downward to axially upward, if the water evaporator has a low temperature with the reforming catalyst layer heated to the high temperature, the supplied water is not evaporated and remain at the water evaporator or at a low position of the passage of the reformer. As a result, sufficient steam is not supplied to the reforming catalyst layer, and only the material flows within the reforming catalyst layer or the passage in a high temperature condition. Because the material mainly contains the organic compound comprised of carbon and hydrogen, it may be thermally decomposed and converted into carbon, which may be deposited on the reforming catalyst or within the passage. This causes degradation of catalytic activity or clogging of the passage, thereby leading to malfunction of an operation of the hydrogen generator.

If the temperature of the reforming catalyst becomes higher than a reforming reaction temperature, catalyst may possibly agglomerate and may thereby degrade its catalytic activity. In addition, if the high-temperature reforming catalyst layer is in air, the reforming catalyst may possibly be oxidized and thereby degrade its catalytic activity.

In the method in which start of water supply is controlled depending on the temperature of the reforming catalyst, the water and the material are supplied and the reforming reaction is conducted when the reforming catalyst reaches the predetermined temperature, irrespective of the temperature condition of the hydrogen generator at the start of the start operation. For this reason, when the hydrogen generator is re-started after an elapse of a short time after the operation of the hydrogen generator has been stopped, the water cannot be supplied to the water evaporator until the reforming catalyst reaches the predetermined temperature, although the water evaporator is in a temperature condition in which the water evaporator can generate the steam from the supplied water. Therefore, the time (hereinafter referred to as start time) elapsed until water supply starts is substantially fixed regardless of whether or not the water evaporator has a temperature high enough to generate the steam at the start of the start operation.

### SUMMARY OF THE INVENTION

The present invention has been developed under the circumstances, and an object of the present invention is to provide a hydrogen generator with high hydrogen generation efficiency and high reliability, which is capable of reducing start time of the hydrogen generator depending on a temperature condition thereof at the start of a start operation, and of increasing a temperature of a water evaporator while inhibiting an excessive temperature increase in a reforming catalyst layer of a reformer, a method of operating the hydrogen generator, and a fuel cell system comprising the hydrogen generator.

According to one aspect of the present invention, there is provided a hydrogen generator comprising: a reformer configured to conduct reforming reaction using a material containing an organic compound comprised of at least carbon atoms and hydrogen atoms, steam, and a reforming catalyst, to generate hydrogen; a material supply portion configured to supply the material to the reformer; a water supply portion configured to supply water to the reformer; a heater configured to heat the reformer; and a controller configured to control supply of the material from the material supply portion and supply of the water from the water supply portion, wherein the reformer includes a water evaporator configured to evaporate the water supplied from the water supply portion, a reforming catalyst layer formed by the reforming catalyst, and a reforming temperature sensor configured to detect a temperature of the reforming catalyst layer, the controller includes a determination portion configured to determine whether or not the water evaporator has a temperature at which the water evaporator can generate the steam based on the temperature of the reforming catalyst layer detected by the reforming temperature sensor, and a supply control portion configured to control at least the supply of the water from the water supply portion to the reformer based on determination of the determination portion, the determination portion is configured to perform a first determination process in such a manner that the determination portion compares the temperature of the reforming catalyst layer detected when the heater starts heating of the reformer to start a start-up operation of the hydrogen generator to a first reference temperature, and the determination portion is configured to perform a second determination process in such a manner that the determination portion compares the temperature of the reforming catalyst layer which is detected while the reformer is heated after the first determination process to a second reference temperature which is higher than the first reference temperature, when the determination portion determines that the temperature of the reforming catalyst layer is not higher than the first reference temperature in the first determination process, and the supply control portion is configured to start supply of the water to the reformer when the determination portion determines that the temperature of the reforming catalyst layer is higher than the first reference temperature in the first determination process or when the determination portion determines that the temperature of the reforming catalyst layer is higher than the second reference temperature in the second determination process.

Thereby, it is possible to achieve a hydrogen generator with high hydrogen generation efficiency and high reliability, which is capable of reducing the start time depending on the temperature condition of the hydrogen generator at the start of the start-up operation and of increasing the temperature of the water evaporator while inhibiting an excessive temperature increase in the reforming catalyst layer.

Preferably, the second reference temperature is set so that catalytic activity of the reforming catalyst layer is not degraded under absence of the steam.

The first reference temperature may be not lower than 50° C. and not higher than 150° C., and the second reference temperature may be not lower than 300° C. and not higher than 500° C.

The reformer may further include a water evaporator temperature sensor configured to detect a temperature of the water evaporator, the controller may include a determination portion configured to determine whether or not the water evaporator has a temperature at which the water evaporator can generate the steam based on the temperature of the water evaporator detected by the water evaporator temperature sensor at the start of the start-up operation of the hydrogen generator, and a supply control portion configured to control at least the supply of the water from the water supply portion to the reformer based on determination of the determination portion, the supply control portion may be configured to start the supply of the water when the determination portion determines that the temperature of the water evaporator is higher than a water evaporator reference temperature at which the water evaporator can generate the steam in determination of the determination portion, and the heater may be configured to heat the reformer when the determination portion determines that the temperature of the water evaporator is not higher than the water evaporator reference temperature, and the supply control portion may be configured to start the supply of the water when the determination portion determines that the temperature of the water evaporator is higher than the water evaporator reference temperature.

According to another aspect of the present invention, there is provided a hydrogen generator comprising: a reformer configured to conduct reforming reaction using a material containing an organic compound comprised of at least carbon atoms and hydrogen atoms, steam, and a reforming catalyst, to generate hydrogen; a material supply portion configured to supply the material to the reformer; a water supply portion configured to supply water to the reformer; a heater configured to heat the reformer; and a controller configured to control supply of the material from the material supply portion and the supply of the water from the water supply portion, wherein the reformer includes a water evaporator configured to evaporate the water supplied from the water supply portion, a reforming catalyst layer formed by the reforming catalyst, and a reforming temperature sensor configured to detect a temperature of the reforming catalyst layer, the controller may include a determination portion configured to determine whether or not the water evaporator has a temperature at which the water evaporator can generate the steam based on the temperature of the reforming catalyst layer detected by the reforming temperature sensor, and a supply control portion configured to control at least the supply of the water from the water supply portion to the reformer based on determination of the determination portion, the determination portion may be configured to perform a first determination process in such a manner that the determination portion compares the temperature of the reforming catalyst layer detected when the heater starts heating of the reformer to start a start-up operation of the hydrogen generator to a first reference temperature, the determination portion is configured to perform a second determination process in such a manner that the determination portion compares the temperature of the reforming catalyst layer which is detected while the reformer is heated after the first determination process to a second reference temperature which is higher than the first reference temperature, when the determination portion determines that the temperature of the reforming catalyst layer is not higher than the first reference temperature in the first determination process, the determination portion is configured to perform a third determination process in such a manner that the determination portion compares the temperature of the reforming catalyst layer which is detected while the reformer is heated after the first determination process to a third reference temperature which is higher than the first reference temperature and lower than the second reference temperature, when the determination portion determines that the temperature of the reforming catalyst layer is not higher than the first reference temperature in the first determination process, and the heater is configured to stop the heating of the reformer when the determination portion determines that the temperature of the reforming catalyst layer is higher than the third reference temperature in the third determination process, and the determination portion is configured to perform a fourth determination process in such a manner that the determination portion compares the temperature of the reforming catalyst layer after the stop of the heating to a fourth reference temperature which is lower than the third reference temperature and higher than the first reference temperature, and the heater is configured to re-start the heating of the reformer when the determination portion determines that the temperature of the reforming catalyst layer is lower than the fourth reference temperature in the fourth determination process.

By repeating the stop and the-restart of the heating in the heater, the water evaporator is heated acceleratively while inhibiting an excessive temperature increase in the reforming catalyst layer.

The third reference temperature may be not lower than 200° C. and not higher than 300° C.

The heater may be configured to heat the reformer so that the temperature of the reforming catalyst layer becomes higher than the third reference temperature, after stop and re-start of the heating of the reformer is performed at least once, or after the heating of the reformer involving the stop and the re-start is performed for a predetermined time period, and the supply control portion may be configured to start the supply of the water when the determination portion determines that the temperature of the reforming catalyst layer is higher than the second reference temperature in the second determination process.

The controller may be configured to decide the number of times the stop and the re-start of the heating are performed or the time period for which the heating involving the stop and the re-start is performed, according to the temperature of the reforming catalyst layer detected at the start of the start-up operation of the hydrogen generator.

The reformer may further include a water evaporator temperature sensor configured to detect a temperature of the water evaporator, the controller may include a determination portion configured to determine whether or not the water evaporator has a temperature at which the water evaporator can generate the steam based on the temperature of the water evaporator detected by the water evaporator temperature sensor, and a supply control portion configured to control at least the supply of the water from the water supply portion based on determination of the determination portion, the heater may be configured to heat the reformer when the determination portion determines that the temperature of the water evaporator is not higher than the water evaporator reference temperature at which the water evaporator can generate the steam in determination of the determination portion, the heater may stop the heating of the reformer when the determination portion determines that the temperature of the reforming catalyst layer reaches the third reference temperature, the heater may be configured to re-start the heating of the reformer when the determination portion determines that the temperature of the reforming catalyst layer reaches the fourth reference temperature after the stop of the heating, and the supply control portion may be configured to start the supply of the water when the determination portion determines that the temperature of the water evaporator is higher than the water evaporator reference temperature, based on a signal output from the water evaporator temperature sensor.

The water evaporator reference temperature may be not lower than 50° C. and not higher than 150° C.

The water evaporator may be located at an outermost portion of the reformer, and the reforming catalyst layer is located inward relative to the water evaporator.

The heater may include a burner configured to combust a combustion fuel and air, a fuel supply portion configured to supply the combustion fuel to the burner, and an air supply portion configured to supply the air to the burner, wherein the reformer may be configured to exchange heat between a combustion exhaust gas generated in the burner and the reforming catalyst layer and then between the combustion exhaust gas and the water evaporator.

The supply control portion may be configured to control supply of the air from the air supply portion to a burner of the heater, the air supply portion may be configured to supply the air to the burner at a first flow rate after the water supply portion starts the supply of the water, the air supply portion may be configured to supply the air to the burner at a second flow rate when the determination portion determines that the temperature of the reforming catalyst layer is not higher than the first reference temperature in the first determination process, and a ratio of the first flow rate to a theoretical air amount in complete combustion of the combustion fuel in combustion performed with the air supplied at the first flow rate is smaller than a ratio of a second flow rate to the theoretical air amount in complete combustion of the combustion fuel in combustion performed with the air supplied at the second flow rate.

The ratio of the second flow rate to the theoretical air amount in the complete combustion of the combustion fuel in the combustion performed with the air supplied at the second flow rate may be not lower than 2.0.

The supply control portion may be configured to inject the air from the air supply portion to a burner of the heater in a heating stop period during which the combustion in the burner is stopped according to determination of the third determination process.

The supply control portion may be configured to start the supply of the material from the material supply portion after an elapse of a predetermined time after the start of the water supply according to determination in the first determination process or after an elapse of a predetermined time after the start of the water supply according to the determination in the second determination process.

By intentionally shifting the timing at which the water is supplied to the reformer relative to the timing at which the material is supplied to the reformer, the gases can be purged from the interior of the hydrogen generator by using the steam generated in the water evaporator before the reforming reaction is conducted.

The water may be reserved in the water evaporator before the temperature of the water evaporator becomes a temperature at which the water evaporator can generate the steam.

According to another aspect of the present invention, there is provided a method of operating a hydrogen generator including: a reformer configured to conduct reforming reaction using a material containing an organic compound comprised of at least carbon atoms and hydrogen atoms, steam, and a reforming catalyst, to generate hydrogen; a material supply portion configured to supply the material to the reformer; a water supply portion configured to supply water to the reformer, a heater configured to heat the reformer; and a controller configured to control supply of the material from the material supply portion and supply of the water from the water supply portion, wherein the reformer includes a water evaporator configured to evaporate the water supplied from the water supply portion, a reforming catalyst layer formed by the reforming catalyst, and a reforming temperature sensor configured to detect a temperature of the reforming catalyst layer, the method comprising the steps of: performing a first determination process in such a manner that the controller compares the temperature of the reforming catalyst layer detected when the heater starts heating of the reformer to start a start-up operation of the hydrogen generator to a first reference temperature; performing a second determination process in such a manner that the controller compares the temperature of the reforming catalyst layer which is detected while the reformer is heated after the first determination process to a second reference temperature which is higher than the first reference temperature, when it is determined that the temperature of the reforming catalyst layer is not higher than the first reference temperature in the first determination process; and starting the supply of the water from the water supply portion to the reformer when it is determined that the temperature of the reforming catalyst layer is higher than the first reference temperature in the first determination process or when it is determined that the temperature of the reforming catalyst layer is higher than the second reference temperature in the second determination process.

Thereby, it is possible to achieve a method of operating the hydrogen generator with high hydrogen generation efficiency and high reliability, which is capable of reducing the start time depending on the temperature condition of the hydrogen generator at the start of the start-up operation and of increasing the temperature of the water evaporator while inhibiting an excessive temperature increase in the reforming catalyst layer.

The reformer may further include a water evaporator temperature sensor configured to detect a temperature of the water evaporator, and the method may further comprise the steps of: starting the supply of the water when it is determined that the temperature of the water evaporator detected by the water evaporator temperature sensor is higher than a water evaporator reference temperature at which the water evaporator can generate the steam; and heating the reformer when it is determined that the temperature of the water evaporator is not higher than the water evaporator reference temperature, and starting the supply of the water when it is determined that the temperature of the water evaporator is higher than the water evaporator reference temperature.

According to another aspect of the present invention, there is provided a method of operating a hydrogen generator including: a reformer configured to conduct reforming reaction using a material containing an organic compound comprised of at least carbon atoms and hydrogen atoms, steam, and a reforming catalyst, to generate hydrogen; a material supply portion configured to supply the material to the reformer; a water supply portion configured to supply water to the reformer, a heater configured to heat the reformer; and a controller configured to control the supply of the material from the material supply portion and the supply of the water from the water supply portion, wherein the reformer includes a water evaporator configured to evaporate the water supplied from the water supply portion, a reforming catalyst layer formed by the reforming catalyst, and a reforming temperature sensor configured to detect a temperature of the reforming catalyst layer, the method comprising the steps of: performing a first determination process in such a manner that the controller compares the temperature of the reforming catalyst layer detected when the heater starts heating of the reformer to start a start-up operation of the hydrogen generator to a first reference temperature; performing a second determination process in such a manner that the controller compares the temperature of the reforming catalyst layer which is detected while the reformer is heated after the first determination process to a second reference temperature which is higher than the first reference temperature, when it is determined that the temperature of the reforming catalyst layer is not higher than the first reference temperature in the first determination process; performing a third determination process in such a manner that the controller compares the temperature of the reforming catalyst layer which is detected while the reformer is heated after the first determination process to a third reference temperature which is higher than the first reference temperature and lower than the second reference temperature, when it is determined that the temperature of the reforming catalyst layer is not higher than the first reference temperature in the first determination process; and stopping the heating of the reformer when it is determined that the temperature of the reforming catalyst layer is higher than the third reference temperature in the third determination process; and performing a fourth determination process in such a manner that the controller compares the temperature of the reforming catalyst layer after the stop of the heating to a fourth reference temperature which is lower than the third reference temperature and higher than the first reference temperature; and re-starting the heating of the reformer when it is determined that the temperature of the reforming catalyst layer is lower than the fourth reference temperature in the fourth determination process.

By repeating the stop and the-restart of the heating in the heater, the water evaporator is heated acceleratively while inhibiting an excessive temperature increase in the reforming catalyst layer.

The method may further comprise: deciding the number of times stop and re-start of the heating of the reformer are performed or a time period for which the heating of the reformer involving the stop and the re-start of the heating of the reformer is performed according to the temperature of the reforming catalyst layer detected at the start of the start-up operation of the hydrogen generator; performing the heating involving the stop and the re-start of the heating of the reformer the decided number of times or for the decided time period; performing the heating so that the reforming catalyst layer becomes higher than the third reference temperature; and starting the supply of the water from the water supply portion to the reformer when it is determined that the temperature of the reforming catalyst layer is higher than the second reference temperature in the second determination process.

The reformer may further include a water evaporator temperature sensor configured to detect a temperature of the water evaporator, and the method may further comprise the steps of: heating the reformer when it is determined that the temperature of the water evaporator detected by the water evaporator temperature sensor is not higher than a water evaporator reference temperature at which the water evaporator can generate the steam; stopping the heating of the reformer when it is determined that the temperature of the reforming catalyst layer is higher than the third reference temperature; re-starting the heating of the reformer when it is determined that the temperature of the reforming catalyst layer after the stop of the heating is lower than the fourth reference temperature; and starting supply of the water when it is determined that the temperature of the water evaporator is higher than the water evaporator reference temperature based on a signal output from the water evaporator temperature sensor.

The heater may include a burner configured to combust a combustion fuel and air, a fuel supply portion configured to supply the combustion fuel to the burner, and an air supply portion configured to supply the air from the air supply portion to the burner, the controller may be configured to control the air supply portion, the air may be supplied from the air supply portion to the burner at a first flow rate in the heating after the water supply portion starts the supply of the water, the air may be supplied from the air supply portion to the burner at a second flow rate when it is determined that the temperature of the reforming catalyst layer is not higher than the first reference temperature in the first determination process at the start of the start-up operation of the hydrogen generator, and a ratio of the first flow rate to a theoretical air amount in complete combustion of the combustion fuel in combustion performed with the air supplied at the first flow rate may be smaller than a ratio of the second flow rate to the theoretical air amount in complete combustion of the combustion fuel in combustion performed with the air supplied at the second flow rate.

The heater may include a burner configured to combust a combustion fuel and air, a fuel supply portion configured to supply the combustion fuel to the burner, and an air supply portion configured to supply the air to the burner, wherein the air is injected from the air supply portion to the burner in a heating stop period during which combustion in the burner is stopped according to determination in the third determination process.

The method may further comprise starting the supply of the material from the material supply portion to the reformer by the controller after an elapse of a predetermined time after start of the supply of the water after the first determination process or after an elapse of a predetermined time after start of the supply of the water after the second determination process.

By intentionally shifting the timing at which the water is supplied to the reformer relative to the timing at which the material is supplied to the reformer, the gases can be purged from the interior of the hydrogen generator by using the steam generated in the water evaporator before the reforming reaction is conducted.

According to another aspect of the present invention, there is provided a fuel cell system comprising the above mentioned hydrogen generator, an air supply device, and a fuel cell configured to cause hydrogen supplied from the hydrogen generator and air supplied from the air supply device to react to generate electric power.

The above and further objects and features of the invention will be more fully be apparent from the following detailed description with accompanying drawings.

### BRIEF DESCRIPTION OF THE DRAWINGS

FIG. 1 is a cross-sectional view schematically showing a construction of a reformer of a hydrogen generator according to a first embodiment of the present invention;

FIG. 2 is a view schematically showing a construction of a controller of the hydrogen generator in FIG. 1;

FIG. 3 is a flowchart schematically showing a content of a program stored in the controller in FIG. 2;

FIGS. 4A and 4B are views showing temperature variations in a reforming catalyst layer and in a water evaporator during an operation of the hydrogen generator in FIG. 1;

FIG. 5 is a flowchart schematically showing a content of a program stored in a controller of a hydrogen generator according to a second embodiment of the present invention;

FIG. 6 is a view showing temperature variations in a reforming catalyst layer and a water evaporator heated according to the program in FIG. 5;

FIG. 7 is a block diagram showing a construction of a fuel cell system according to an eighth embodiment of the present invention;

FIG. 8 is a cross-sectional view schematically showing a construction of a reformer of a hydrogen generator according to a fourth embodiment of the present invention; and

FIG. 9 is a flowchart schematically showing a content of a program stored in a controller of the hydrogen generator according to the fourth embodiment of the present invention.

### DETAILED DESCRIPTION OF THE PREFERRED EMBODIMENTS

Hereinafter, embodiments of the present invention will be described with reference to the drawings.

### Embodiment 1

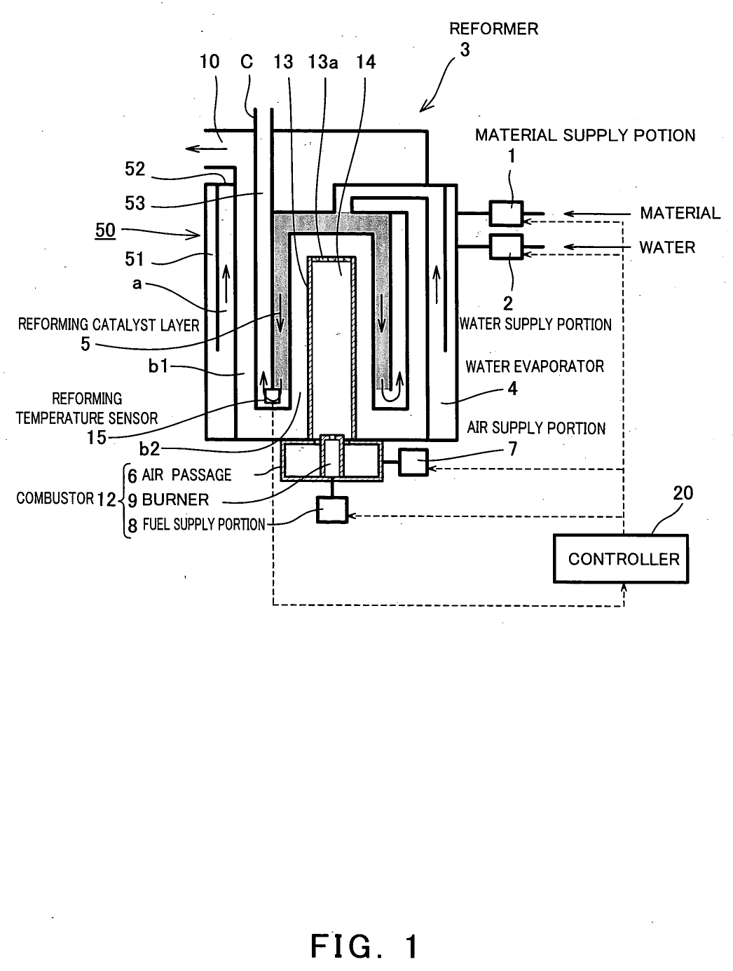

FIG. 1 is a cross-sectional view schematically showing a construction of a hydrogen generator according to a first embodiment of the present invention, and in particular, showing, in detail, a construction of a reformer as a major component of the hydrogen generator and its surroundings.

As shown in FIG. 1, the hydrogen generator comprises a reformer 3 formed by a cylindrical body 50 with its upper and lower ends closed, a material supply portion 1 configured to supply a material containing an organic compound comprised of carbon and hydrogen, a water supply portion 2 configured to supply water to the reformer 3, a combustor (heater) 12 configured to heat the reformer 3, a fuel supply portion 8 configured to supply a combustion fuel to the combustor 12, an air supply portion 7 configured to supply air to the combustor 12, and a controller 20.

The reformer 3 is constructed such that a plurality of vertical walls 51 which varies in length in radial and axial directions of the cylindrical body 50 are arranged concentrically within the body 50 to define an interior of the body 50 in the radial direction. Horizontal walls 52 in circular-plate shape or hollow-circular-plate shape are suitably provided at predetermined end portions of the vertical walls 51. The plurality of vertical walls 51 are vertically provided concentrically within the body 50 to form gaps 53 between the vertical walls 51. The predetermined end portions of the vertical walls 51 are suitably closed by the horizontal wall 52 to form desired gas passages utilizing the gaps 53. Thereby, within the body 50, a reforming material passage a, a combustion gas passage b1, a reformed gas passage c, a reforming catalyst layer 5, and a combustion gas passage b2 are arranged in this order in the direction from an outer peripheral side toward the center in the radial direction of the body 50.

An upstream end portion of the reforming material passage a is fluidically connected to the material supply portion 1 and the water supply portion 2 provided outside the body 50, and a downstream end portion thereof is fluidically connected to an upper end surface of the reforming catalyst layer 5. The reforming material passage a has a double-walled structure and configured such that the flow direction of the material flowing within the passage a changes from axially downward to axially upward. A water evaporator 4 is formed at a bottom portion of the reforming material passage a. As described later, the water supplied from the water supply portion 2 is reserved in the water evaporator 4 and evaporated therein.

The reforming catalyst layer 5 is formed by a reforming catalyst filled in the gap 53. The reforming catalyst layer 5 extends along an upper end surface and an outer peripheral surface of a radiation tube 13 of the combustor 12 to be described later. In this embodiment, the reforming catalyst containing Ru as a major component is used, which is not to be interpreted as a limiting. The reforming catalyst may contain other suitable material so long as it enables reforming reaction. By way of example, the reforming catalyst may contain a noble metal such as Pt or Rh, Ni, etc. An upper end surface of the reforming catalyst layer 5 is fluidically connected to the reforming material passage a, and a lower end surface thereof is fluidically connected to an upstream end portion of the reformed gas passage c. A downstream end portion of the reformed gas passage c is configured to allow the reformed gas to be taken out from the reformer 3. Within the reformed gas passage c, a reforming temperature sensor 15 is provided to detect a temperature of a gas which has passed through the reforming catalyst layer 5 and is flowing within the passage c. In the first embodiment, a thermocouple is provided as the reforming temperature sensor 15. The reforming temperature sensor 15 may be provided at other suitable locations so long as the sensor 15 can detect the temperature of the gas which has passed through the reforming catalyst layer 5. In addition, while the reforming temperature sensor 15 is configured to detect the temperature of the gas which has just passed through the reforming catalyst layer 5, and the detected temperature of the gas is the temperature of the reforming catalyst layer 5, the temperature within the reforming catalyst layer 5 may be directly detected, or the temperature of the vertical walls 51 or the horizontal walls 52 forming the reforming catalyst layer 5 may be detected. Temperature information regarding the temperature of the reforming catalyst layer 5 detected by the reforming temperature sensor 15 is communicated to the controller 20. According to the temperature information, the controller 20 outputs signals to the material supply portion 1 and the water supply portion 2 to instruct the material supply portion 1 and the water supply portion 2 to start supply of the material and the supply of the water, as the configuration and function of the controller 20 will be described later.

The combustor 12 includes a burner 9, an air passage 6 formed on an outer periphery of the burner 9, and the radiation tube 13 disposed on the air passage 6 so as to protrude upward from the air passage 6. The radiation tube 13 is concentrically housed within the body 50 of the reformer 3. The burner 9 is connected to the fuel supply portion 8, and the air passage 6 is connected to the air supply portion 7. The combustion fuel is supplied from the burner 9 to the inside of the radiation tube 13 and the air is supplied from the air supply portion 7 to the inside of the radiation tube 13. The combustion fuel and the air are combusted in the radiation tube 13 to form a flame. In this manner, a combustion space 14 is formed within the radiation tube 13. The combustion space 14 communicates with the combustion gas passage b2 of the reformer 3 through an opening 13a formed at an upper end of the radiation tube 13. The combustion gas passage b2 and the combustion gas passage b1 communicate with each other at the bottom portion of the reformer 3. A downstream end portion of the combustion gas passage b1 is configured to allow the combustion gas to be taken outside from the reformer 3.

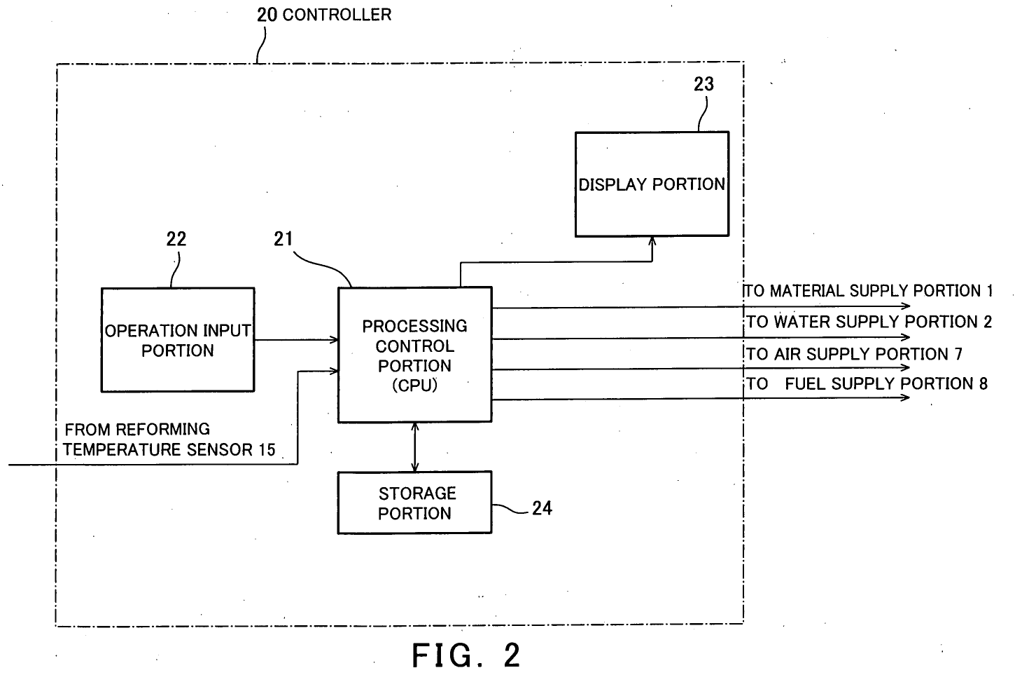

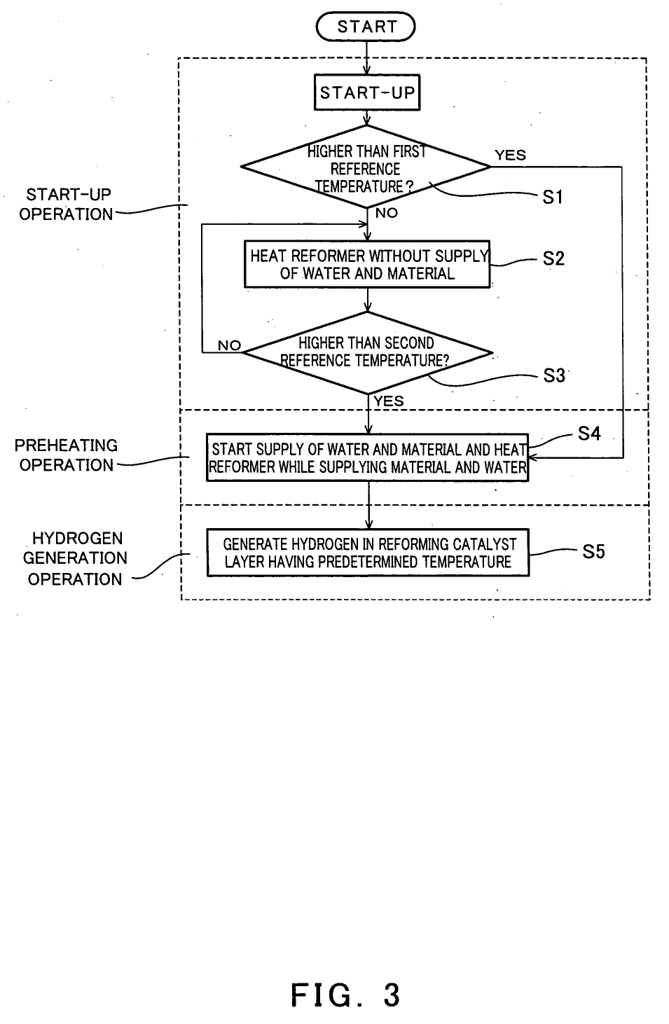

FIG. 2 is a block diagram showing a configuration of the controller 20 of the hydrogen generator. FIG. 3 is a flowchart schematically showing a content of a program stored in the controller 20 in FIG. 2. As shown in FIG. 2, the controller 20 is configured by a computer such as a micro computer, and includes a processing control portion (CPU) 21, an operation input portion 22, a display portion 23, and a storage portion 24. The controller 20 is communicatively connected to the material supply portion 1, the water supply portion 2, the fuel supply portion 8, and the air supply portion 7, and configured to control amounts of supply of the material, the water, the combustion fuel, and the air in these portions 1, 2, 8, and 7. As will be described later, the processing control portion 21 functions as a determination portion configured to determine whether or not the water evaporator 4 has the temperature at which the water evaporator 4 can generate the steam, based on the temperature of the reforming catalyst layer detected by the reforming temperature sensor 15. In addition, the processing control portion 21 also functions as a supply control portion configured to control water supply to the water evaporator 4. Although not shown, the material supply portion 1, the water supply portion 2, the air supply portion 7, and the fuel supply portion 8 are each capable of adjusting the flow rate of the fluid. For example, these portions 1, 2, 7, and 8 may be each equipped with a drive means such as a pump or a fan, which may be configured to be controlled by the controller 20 for adjustment of the flow rate. In addition, a flow rate control device such as a valve may be provided in a passage downstream of the drive means and configured to be controlled by the controller 20 for adjustment of the flow rate.

Subsequently, an operation of the hydrogen generator will be described. The operation of the hydrogen generator involves an operation for heating the reformer 3 up to a temperature at which the water evaporator 4 can generate steam (hereinafter referred to as a start-up operation), an operation for heating the reformer 3 until the temperature of the reforming catalyst layer 5 becomes a reforming reaction temperature while supplying water to the water evaporator 4 heated to the above temperature (hereinafter referred to as a preheating operation), and an operation for generating hydrogen through the reforming reaction in the reforming catalyst layer 5 (hereinafter referred to as a hydrogen generation operation).

In the start-up operation, supply of the material and supply of the water to the reformer 3 are stopped. When the water evaporator 4 reaches the temperature at which the water evaporator 4 can generate the steam, the material and the water start to be supplied to the reformer 5, and the start-up operation transitions to the preheating operation. When the reforming catalyst layer 5 reaches the reforming reaction temperature (e.g., 500 to 700° C.) by the preheating operation, hydrogen is generated through the reforming reaction from the material and the steam using the reforming catalyst layer, and thus, the preheating operation transitions to the hydrogen generation operation. As used herein, a time period elapsed from when the hydrogen generator starts a start-up operation, i.e., when the combustor 12 starts combustion, until the water is supplied to the water evaporator 4, is referred to as a start time required for the start-up operation of the hydrogen generator.

As shown in FIG. 3, the start-up operation, the preheating operation, and the hydrogen generation operation are executed according to a program stored in the controller 20. Hereinafter, the operation of the hydrogen generator will be described according to a process of the program in FIG. 3.

Referring to FIG. 3, in response to an operation start signal from the processing control portion 21 of the controller 20, the start-up operation starts. Specifically, the combustion fuel is supplied from the fuel supply portion 8 to the combustor 12 at a predetermined flow rate, and the air is supplied from the air supply portion 7 to the combustor 12 at a predetermined flow rate. Here, air which is 1.5 times as much as theoretical air amount in perfect combustion of the combustion fuel supplied to the combustor 12 is supplied to the combustor 12. In order to achieve stable combustion in the combustor 12, the amounts of the combustion fuel and the air supplied to the combustor 12 during an operation of the hydrogen generator are kept constant.

In the combustor 12, the combustion fuel and the air are combusted to generate a flame in the combustion space 14. And, the reforming catalyst layer 5 is heated by both the heat resulting from the combustion and the heat of the combustion gas introduced from the combustion space 14 into the combustion gas passage b2 and flowing through the combustion gas passage b2. Since the combustion gas passage b1 is in contact with the reforming material passage a with the vertical wall 51 interposed between them, the heat of the combustion gas introduced from the combustion gas passage b2 into the combustion gas passage b1 and flowing through the combustion gas passage b1 is transferred to the reforming material passage a. Thereby, the water evaporator 4 formed at the bottom portion of the reforming material passage a is heated. Thus, both the reforming catalyst layer 5 and the water evaporator 4 are heated by the combustion of the combustor 12. The reforming catalyst layer 5 located upstream in heat transfer is heated before the water evaporator 4 located downstream is heated.

While the reformer 3 is heated, the temperature of the reforming catalyst layer 5 is always detected by the reforming temperature sensor 15, and the detected temperature is communicated to the controller 20. Referring to FIG. 3, the processing control portion 21 compares a first reference temperature T1 preset in the processing control portion 21 to the detected temperature of the reforming catalyst layer 5, and determines whether or not the temperature of the reforming catalyst layer 5 is higher than the first reference temperature T1 (step S1). In this embodiment, the first reference temperature T1 is 100° C. When it is determined that the temperature of the reforming catalyst layer 5 is higher than the first reference temperature T1, the processing control portion 21 outputs control signals to the material supply portion 1 and the water supply portion 2. Thereby, the material and the water start to be supplied to the reformer 3 and the start-up operation transitions to the preheating operation (step S4).

On the other hand, when it is determined that the temperature of the reforming catalyst layer 5 is not higher than the first reference temperature T1, the reformer 3 continues to be heated without supplying the material and the water (step S2). In this heating process, the processing control portion 21 compares a second reference temperature T2 present in the processing control portion 21 to the detected temperature of the reforming catalyst layer 5 to determine whether or not the temperature of the reforming catalyst layer 5 is higher than the second reference temperature T2 (step S3). In this embodiment, the second reference temperature T2 is 400° C. When it is determined that the temperature of the reforming catalyst layer 5 is not higher than the second reference temperature T2, the reformer 3 continues to be heated. On the other hand, when it is determined that the temperature of the reforming catalyst layer 5 is higher than the second reference temperature T2, the processing control portion 21 outputs control signals to the material supply portion 1 and the water supply portion 2. Thereby, the material and the water start to be supplied to the reformer 3, and thus, the start-up operation transitions to the preheating operation (step S4).

In the preheating operation, the material supplied from the material supply portion 1 and the steam generated in the water evaporator 4 from the water supplied from the water supply portion 2 are supplied to the reforming catalyst layer 5 through the reforming material passage a, flow through the reforming catalyst layer 5 to the reformed gas passage c. The resulting reformed gas is taken out from the reformer 3 through the reformed gas passage c. In the reforming catalyst layer 5 heated while flowing the material and the steam therethrough, when the reforming reaction temperature is reached, hydrogen is generated through the reforming reaction using the material and the steam (step S5). The reforming reaction does not start abruptly at a threshold temperature, but part of the material and part of the steam start to react when the temperature of the reforming catalyst layer 5 becomes approximately 500° C., and the amounts of the material and the steam which react increase with increasing temperature. At approximately 700° C., substantially all the material and the steam react. Therefore, in the preheating operation in which the reformer 3 is heated while supplying the material and the steam as described above, the reforming reaction is started appropriately if the temperature condition of the reforming catalyst layer 5 is satisfied. So, in the first embodiment, the operation in which the material and the steam supplied to the reformer 3 under the temperature condition of, for example, approximately, 700° C., react substantially completely to generate hydrogen, is defined as the hydrogen generation operation. While the operation for heating the reformer 3 until the reforming catalyst layer 5 reaches the reforming reaction temperature is defined as the preheating operation, hydrogen is partially generated through the reforming reaction from the material and the steam even during the preheating operation.

The hydrogen generation operation of the hydrogen generator of the first embodiment is similar to that of the existing hydrogen generator. Specifically, the material and the steam supplied to the reforming catalyst layer 5 through the reforming material passage a and the reforming catalyst, allow generation of the reformed gas containing hydrogen as a major component in the reforming catalyst layer 5. The generated reformed gas, i.e., hydrogen is taken out from the reformer 3 through the reformed gas passage c.

The first and second reference temperatures T1 and T2 which are references for determining whether or not the material and the water start to be supplied in steps S1 and S3 of the start-up operation are set considering temperature variations in the reforming catalyst layer 5 and the water evaporator 4, and the relationship between the temperature of the reforming catalyst layer 5 and the temperature of the water evaporator 4 during a start-up operation (heating), a stop operation (cooling), and a stopped state (cooling) of the hydrogen generator. By controlling timings at which the material and the water start to be supplied based on the first and second reference temperatures T1 and T2, the start time can be reduced.

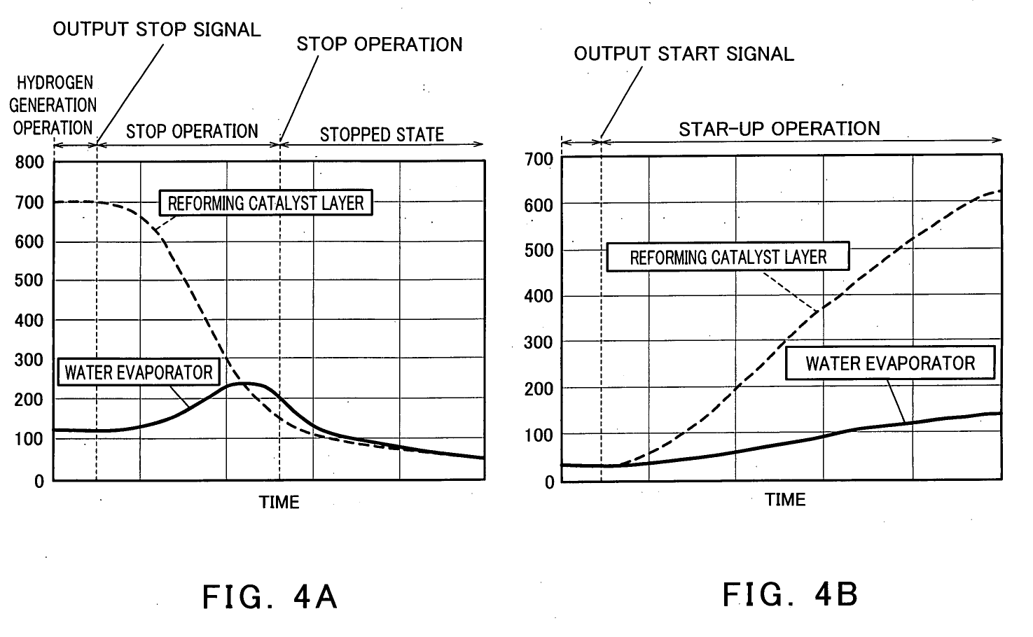

Hereinafter, this effect will be described in detail with reference to FIGS. 4A and 4B. FIG. 4A is a view showing time-elapse temperature variations in the reforming catalyst layer 5 and the water evaporator 4 during and after a stop operation of the hydrogen generator. The stop operation means an operation performed from when the processing control portion 21 of the controller 20 outputs an operation stop signal to the hydrogen generator until the hydrogen generator completely stops.

As can be seen from FIG. 4A, in the hydrogen generator during the hydrogen generation operation, the temperature of the reforming catalyst layer 5 is kept at approximately 700° C., while the temperature of the water evaporator 4 is kept at approximately 120° C. In accordance with the operation stop signal from the processing control portion 21, the hydrogen generator enters the stop operation, and the material supply portion 1, the water supply portion 2, and the fuel supply portion 8 stop, thereby causing the reforming reaction in the reformer 3 and the combustion in the combustor 12 to stop.

At this time, the air is blown from the air supply portion 7 to the burner 9 to quickly lower the temperature of the reforming catalyst layer 5, and to increase the temperature of the water evaporator 4 located downstream of the reforming catalyst layer 5 in the flow of air by the heated air.

When the combustion in the combustor 12 stops and the heating of the reformer 3 stops, the reforming catalyst layer 5 kept at the high temperature during the hydrogen generation operation rapidly lowers its temperature. Since the temperature of the water evaporator 4 is lower than the temperature of the reforming catalyst layer 5 during the hydrogen generation operation, the temperature of the water evaporator 4 does not reduce so rapidly as the reforming catalyst layer 5 after the stop of the heating. Conversely, because the reforming reaction which is an endothermic reaction is not conducted, the water evaporator 4 continues to be heated to increase in temperature, by heat radiation from the reforming catalyst layer 5 or by heat exchange with the air. As should be appreciated, since the temperature of the reforming catalyst layer 5 decreases but the temperature of the water evaporator 4 increases in the combustion stop operation, the temperature of the water evaporator 4 becomes higher than that of the reforming catalyst layer 5 after an elapse of predetermined time after the combustion stop operation starts. After the relationship of temperature between the reforming catalyst layer 5 and the water evaporator 4 is reversed, the temperature increase in the water evaporator 4 stops. When the temperature of the reforming catalyst layer 5 becomes approximately 150° C. and the temperature of the water evaporator 4 becomes 180° C., the operation of the air supply portion 7 stops, and thereby, the hydrogen generator completely stops. After the hydrogen generator has stopped, the temperature of the hydrogen generator, including those of the reforming catalyst layer 5 and the water evaporator 4 gradually decreases to a room temperature.

When the hydrogen generator re-starts the operation in a short time after the stop of the hydrogen generator, the water evaporator 4 and the reforming catalyst layer 5 are kept at relatively high temperatures. If the water evaporator 4 is at a temperature of 100° C. or higher, the water can be immediately supplied to the water evaporator 4 to generate the steam.

As should be appreciated from FIG. 4A, when the temperature of the reforming catalyst layer 5 is not lower than 100° C., the temperature of the water evaporator 4 is always higher than 100° C. Based on this, the first reference temperature T1 of the reforming catalyst layer 5 is set to 100° C., and when the temperature of the reforming catalyst layer 5 detected by the reforming temperature sensor 15 is higher than the first reference temperature T1 at the start of the start-up operation of the hydrogen generator, the water evaporator 4 can generate the steam from the water supplied from the water supply portion 2 to the water evaporator 4.

On the other hand, when a long time elapses after the hydrogen generator has stopped, the temperatures of the water evaporator 4 and the reforming catalyst layer 5 are approximately as low as a room temperature. When the hydrogen generator re-starts the operation in this state, it is necessary to sufficiently heat the water evaporator 4 up to the temperature at which the water evaporator 4 can generate the steam.

FIG. 4B is a view showing time-elapse temperature variations in the reforming catalyst layer 5 and the water evaporator 4 in a case where the hydrogen generator re-starts under the condition in which the temperature of the water evaporator 4 and the temperature of the reforming catalyst layer 5 are as low as the room temperature after an elapse of a long time after the hydrogen generator has stopped.

As can be seen from FIG. 4B, the reforming catalyst layer 5 which is located near the combustor 12 increases in temperature by the heating in the combustor 12, and thereafter, the water evaporator 4 increases in temperature. Since the reforming catalyst layer 5 is heated in preference to the water evaporator 5 in the heating of the reformer 3, it takes time to heat the water evaporator 4 up to the temperature at which the water evaporator 4 can generate the steam. But, the temperature of the reforming catalyst layer 5 becomes 400° C., it may be determined from the experimental result that the temperature of the water evaporator 4 is higher than 100° C. Therefore, the second reference temperature T2 of the reforming catalyst layer 5 is set to 400° C. The reforming temperature sensor 15 detects the temperature of the reforming catalyst layer 5, and the water may be supplied to from the water supply portion 2 to the water evaporator 4 when the temperature of the reforming catalyst layer 5 becomes higher than the second reference temperature T2, because it may be determined that the temperature of the water evaporator 4 is higher than 100° C. Under this condition, the steam can be generated reliably.

As should be appreciated from the foregoing, the timing at which the steam can be generated varies and the start time varies depending on the temperature condition of the hydrogen generator at the start of operation (i.e., at the start of the start-up operation) of the hydrogen generator. Accordingly, in the first embodiment, as described below, the timing at which the water starts to be supplied to the reformer 3 depending on the temperature condition of the hydrogen generator (temperature condition of the reforming catalyst layer 5) at the start of the start-up operation of the hydrogen generator, thereby reducing the start time.

More specifically, the first reference temperature T1 is set to determine whether or not the water can be supplied to the water evaporator 4, i.e., the water evaporator 4 can generate the steam from the supplied water at the start of the start-up operation, and the second reference temperature T2 is set to determine whether or not the water evaporator 4 has been heated in the start-up operation up to the temperature at which the water evaporator 4 can generate the steam. As described above, the first reference temperature T1 is set to 100° C. and the second reference temperature T2 is set is set to 400° C.

For example, when the operation of the hydrogen generator re-starts in a short time after the stop, the reforming catalyst layer 5 and the water evaporator 4 are kept at high temperatures. As can be seen from FIG. 4A, if the temperature of the reforming catalyst layer 5 is higher than 100° C. which is the first reference temperature T1, the temperature of the water evaporator 4 is not lower than 100° C. When the temperature of the reforming catalyst layer 5 detected by the reforming temperature sensor 15 is higher than the first reference temperature T1, water supply to the reformer 3 can be immediately started, and thereby, the start-up time can be reduced. In this case, the reforming catalyst layer 5 is heated with the steam sufficiently supplied to the reforming catalyst layer 5, it is possible to inhibit degradation of catalytic performance which may be caused by the temperature increase in the reforming catalyst layer 5 or deposition of carbon from the material which may be caused by deficiency of the steam.

While the first reference temperature T1 is set to 100° C. as described above, the first reference temperature T1 may have other suitable values from which it can be determined that the water evaporator 4 can generate the steam, and may suitably be set according to, for example, the construction of the reformer 3. The first reference temperature T1 may be set in a range of 50 to 150° C. Since it is estimated, in this temperature range, that the water evaporator 4 can immediately generate the steam, because the water evaporator 4 has heat remaining after the previous operation. The reason why the first reference temperature T1 may be as low as approximately 50° C., is that the temperature of the water evaporator 4 may possibly be 100° C. or higher regardless of the low temperature of the reforming catalyst layer 5 when the air is supplied to the reformer 3 in large amount through the air passage 6 of the combustor 12 to cool the reformer 3, in the stop operation of the hydrogen generator.

On the other hand, when the operation of the hydrogen generator re-starts after an elapse of a long time after the stop, the temperature of the reforming catalyst layer 5 and the temperature of the water evaporator 4 are as low as the room temperature, and the temperature of the reforming catalyst layer 5 at the start of the start-up operation is lower than 100° C. which is the first reference temperature T1. In this case, therefore, the water evaporator 4 cannot generate the steam from the supplied water. For this reason, supply of the water is not started immediately, and the combustor 12 performs combustion to heat the reformer 3 for a predetermined time. Then, it is determined whether or not the heated water evaporator 4 can generate the steam, based on the second reference temperature T2. Since the reforming catalyst layer 5 is heated in preference to the water evaporator 4 in the start-up operation, the temperature of the water evaporator 4 does not increase up to that at which the water evaporator 4 can generate the steam until the temperature of the reforming catalyst layer 5 increases to some degrees. When the temperature of the reforming catalyst layer 5 becomes higher than 400° C. which is the second reference temperature T2, it may be determined that the water evaporator 4 has been sufficiently heated to the temperature of 100° C. or higher. Therefore, when the temperature of the reforming catalyst layer 5 detected by the reforming temperature sensor 15 is higher than the second reference temperature T2, the water can start to be supplied to the water evaporator 4. By controlling the timing at which the water is supplied to the water evaporator 4 based on comparison with the second reference temperature T2, the reforming catalyst layer 5 is further heated with the steam sufficiently supplied to the reforming catalyst layer 5. Consequently, it is possible to inhibit degradation of catalytic performance which may be caused by the temperature increase in the reforming catalyst layer 5 or deposition of carbon from the material which may be caused by deficiency of the steam.

The second reference temperature T2 is not intended to be limited to 400° C. The second reference temperature T2 may have other suitable values so long as it may be determined from these values that the reforming catalyst layer 5 has the temperature at which the water evaporator 4 can generate the steam and degradation of the reforming catalyst or deposition of carbon from the material under the absence of the steam does not take place, and may suitably be set according to the configuration of the reformer 3 or the like. For example, if the temperature of the reforming catalyst layer 5 is higher than 500° C., the temperature of the reforming catalyst or the temperature of the container and passage filled with the reforming catalyst become higher than 500° C. Under this temperature condition, if the steam is absent, the material supplied to the reformer 3 may be thermally decomposed, thereby causing deposition of carbon within the passage or on the reforming catalyst of the reformer 3, or agglomeration or oxidization of the reforming catalyst takes place without the supplied material in the reformer 3. In any case, problems such as clogging of the passage or degradation of catalytic activity may arise. It is therefore desirable to set the second reference temperature T2 in the range of 300 to 500° C.

As should be appreciated from the foregoing, in the hydrogen generator of the first embodiment, since the timing at which the water starts to be supplied to the water evaporator 4 can be controlled depending on the temperature condition of the water evaporator 4 at the start of the start-up operation, the time required for the start-up operation can be reduced if the water evaporator 4 at the start of the start-up operation has the temperature at which the water evaporator 4 can generate the steam. In addition, since the reforming catalyst layer 5 is heated with the steam sufficiently supplied to the reforming catalyst layer 5, it becomes possible to inhibit deposition of carbon within the passage or on the reforming catalyst of the reformer 3 which may be caused by thermal decomposition of the material or agglomeration or oxidization of the reforming catalyst. In addition, since the water is supplied to the water evaporator 4 which is ready to generate the steam, the water evaporator 4 can reliably generate the steam. Consequently, it is possible to inhibit, for example, the liquid water from clogging the passage. Thus, the hydrogen generator constructed as described above can achieve high reliability.

Since in the above constructed hydrogen generator, the water evaporator 4 is located at an outermost portion of the reformer 3, the heat radiated from the reforming catalyst layer 5 in the high-temperature condition toward an outer side can be used as latent heat of water evaporation in the water evaporator 4. This makes it possible to inhibit the temperature increase in the water evaporator 4. Since the temperature increase in the water evaporator 4 located at the outermost portion of the reformer 3 is thus inhibited, the surface temperature of the body 50 of the reformer 3 decreases. This makes it possible to inhibit heat radiation from the surface of the body 50. Consequently, heat energy efficiency of the hydrogen generator can be increased.

The construction of the reformer 3 is not intended to be limited to the above. The shape and the internal structure of the body 50, placement of the passages within the reformer 3, etc, are not intended to be limited to the above, either. In the construction in which the water evaporator 4 is located at the outermost portion of the reformer 3 to inhibit the heat radiation from the surface of the body 50, since the heat generated by the combustion in the combustor 12 is difficult to transfer to the water evaporator 4, the temperature of the reformer 3 increases noticeably, but the temperature of the water evaporator 4 is less likely to increase, thereby causing degradation of the catalyst, deposition of carbon from the material, etc, in the conventional heating method. So, in the above construction, the present invention is more effective.

While the reforming temperature sensor 15 configured to detect the temperature of the reforming catalyst layer 5 is located at the position where the sensor 15 detects the temperature of the gas which has just passed through the reforming catalyst layer 5 and is flowing within the reformed gas passage c, and the timing at which the water is supplied varies based on the detected temperature, it may be placed at other suitable locations, so long as the sensor 15 can detect the temperature which has a high correlation with the temperature of the reforming catalyst layer 5 in or in the vicinity of the reforming catalyst layer 5, and based on the detected temperature, it can be determined whether or not the water evaporator 4 can generate the steam, including the temperature detected by the temperature sensor provided at a suitable location of the surface of the reformer 3 including the reforming catalyst layer 5, the temperature detected by the temperature sensor provided at a suitable location of the passages a and c within the reformer 3 through which the steam, the material and the reformed gas flow, the temperature detected by the temperature sensor provided at a suitable location of the combustion space 14, or the temperatures detected by the temperature sensors provided at suitable locations of the combustion gas passages b1 and b2.

It will be appreciated that, in this case, the second reference temperature T2 should be set so that degradation of the reforming catalyst or carbon deposition from the supplied material will not take place in the absence of the steam, based on the correlation with the highest temperature of the reforming catalyst layer 5.

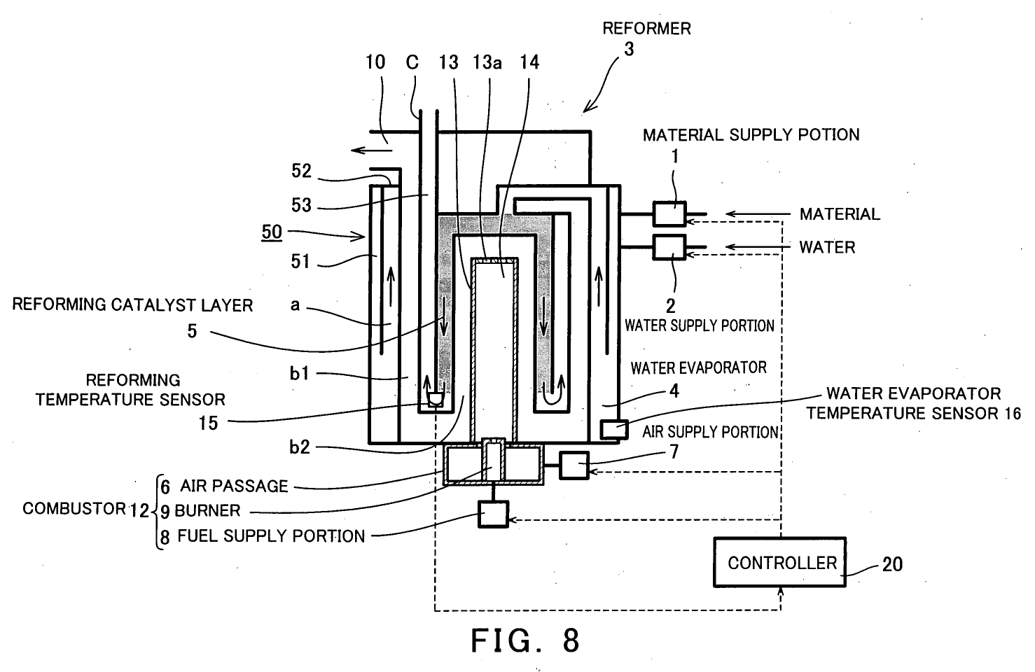

As will be described later, a water evaporator temperature sensor 16 (FIG. 8) configured to detect the temperature of the water evaporator 4 may be provided at a suitable location of the outer surface of or within the water evaporator 4 to directly measure the temperature associated with evaporation of the water evaporator 4. By doing so, the state of the water evaporator 4 can be detected with higher precision, and thereby the steam can be supplied reliably.

### Embodiment 2

The construction of a hydrogen generator according to a second embodiment of the present invention is substantially identical to that of the first embodiment, and will not be further described. In a start-up operation of the hydrogen generator so constructed, the first and second reference temperatures T1 and T2 are set, and based on these reference temperatures T1 and T2, it is determined whether or not the water evaporator 4 has a temperature condition for water evaporation, as in the first embodiment. In the second embodiment, furthermore, a third reference temperature T3 and a fourth reference temperature T4 are set, and based on the third and fourth reference temperatures T3 and T4, the heating state of the reforming catalyst layer 5 is controlled. More specifically, in the second embodiment, the reformer 3 is heated more actively than in the first embodiment. By doing so, it will be possible to reduce the time required for heating the water evaporator 4 up to the temperature at which the water evaporator 4 can generate the steam, even when the hydrogen generator is re-started under the state in which the water evaporator 4 and the reforming catalyst layer 5 are as low as the room temperature after an elapse of a long time after the hydrogen generator has stopped. If the temperature of the reformer 3 (reforming catalyst layer 5) is increased excessively, the reforming catalyst undesirably degrades. Or, if the temperature increasing operation for the reformer 3 is stopped to inhibit the degradation of the reforming catalyst, the reformer 3 is undesirably cooled excessively. In view of these, the reformer 3 is temperature-controlled by the controller 20 as will be described below.

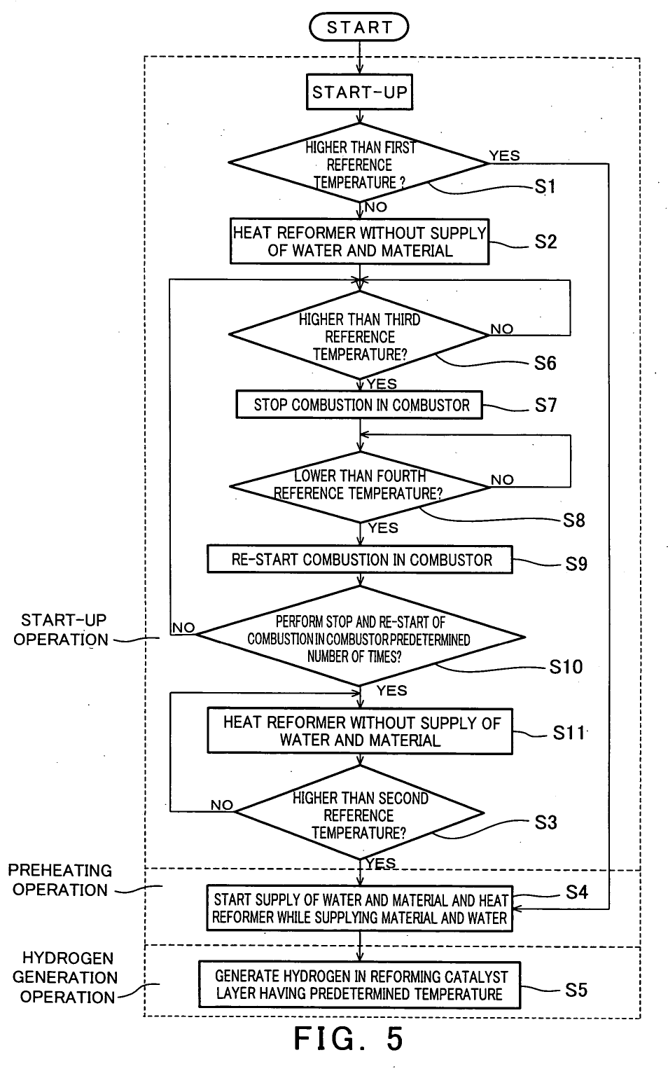

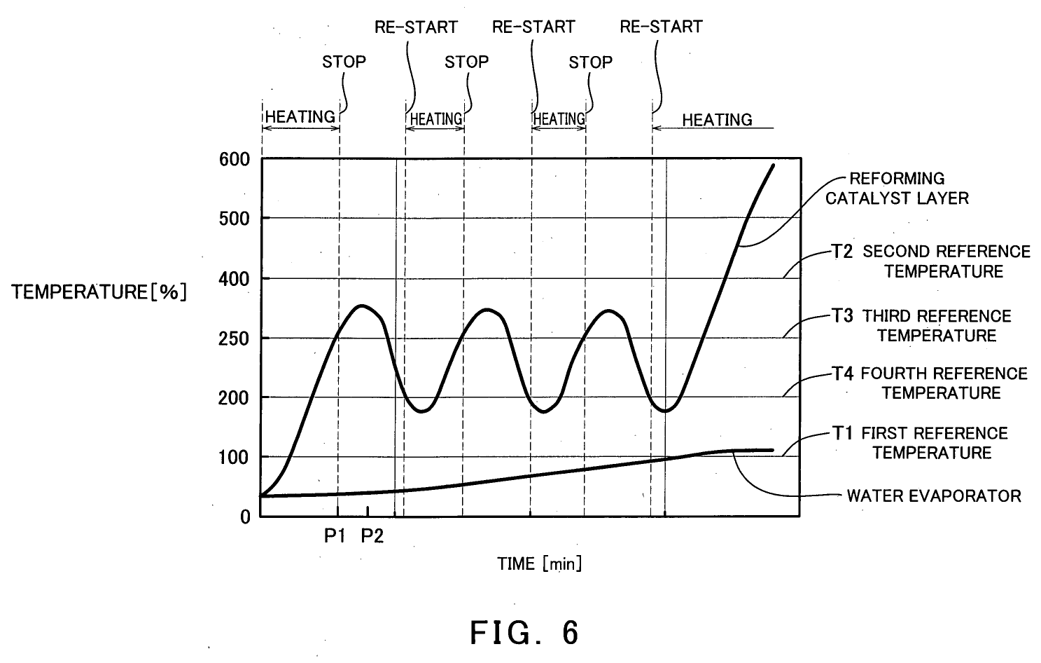

Hereinafter, the start-up operation of the second embodiment will be described with reference to FIGS. 5 and 6.

FIG. 5 is a flowchart schematically showing a content of a program stored in the controller 20 (FIG. 1) of the hydrogen generator of the second embodiment. As shown in FIG. 5, as in the first embodiment, the processing control portion 21 of the controller 20 outputs the operation start signal, and in response to this signal, the hydrogen generator starts the operation. The combustion fuel and the air are respectively supplied from the fuel supply portion 8 and the air supply portion 7 to the combustor 12, which performs combustion. Thereby, the start-up operation is started. The reforming temperature sensor 15 detects the temperature of the reforming catalyst layer 5 at the start of the start-up operation and communicates detected temperature information to the processing control portion 21. The processing control portion 21 compares the detected temperature of the reforming catalyst layer 5 to the first reference temperature T1 (1001C) (step S1). When it is determined that the temperature of the reforming catalyst layer 5 is higher than the first reference temperature T1, the process goes to step S4, as previously described in the first embodiment. On the other hand, when it is determined that the temperature of the reforming catalyst layer 5 is not higher than the first reference temperature T1, the process goes to step S2 as described in the first embodiment. In step S2, the reforming catalyst layer 5 and the water evaporator 4 are heated to enable the process to go to step S3.

In the start-up operation of the second embodiment, steps S6 through S10 are performed between steps S2 and S3 performed as described in the first embodiment. Thereby, heating calories of the reforming catalyst layer 5 are adjusted by stopping and re-starting the combustion in the combustor 12 depending on the temperature condition of the reforming catalyst layer 5 as shown in FIG. 6 until the temperature of the reforming catalyst layer 5 increases up to the second reference temperature T2.

FIG. 6 is a view showing the heating states of the reforming catalyst layer 5 and the water evaporator 4 in the start-up operation of the hydrogen generator of the second embodiment. As shown in FIG. 5, in the second embodiment, the third and fourth reference temperatures T3 and T4 are set between the first and second reference temperatures T1 and T2 of the first embodiment. The third reference temperature T3 is higher than the fourth reference temperature T4 (T3>T4). In the second embodiment, the third reference temperature T3 is set to 250° C. and the fourth reference temperature T4 is set to 200° C.

For example, the temperature at the start of the start-up operation of the hydrogen generator is lower than the first reference temperature T1 (100° C.). Therefore, as shown in step S2 in FIG. 5, the reforming catalyst layer 5 and the water evaporator 4 are heated without supplying the water to the water evaporator 4. In this heating process, it is determined whether or not the detected temperature of the reforming catalyst layer 5 is higher than the third reference temperature T3 (step S6). When it is determined that the detected temperature is lower than the third reference temperature T3, heating continues. On the other hand, when it is determined that the detected temperature of the reforming catalyst layer 5 is higher than the third reference temperature T3, combustion in the combustor 12 is stopped (step S7). Upon the stop of the combustion, the temperature of the reforming catalyst layer 5 decreases, while the temperature of the water evaporator 4 increases by the heat radiation from the reforming catalyst layer 5. Following this, if the temperature of the reforming catalyst layer 5 is lower than the fourth reference temperature T4 (step S8), combustion is re-started in the combustor 12 (step S9). Upon the re-start of the combustion, the temperature of the reforming catalyst layer 5 increases again and the temperature of the water evaporator 4 continues to increase. If the temperature of the reforming catalyst layer 5 becomes not lower than the third reference temperature T3 again after the re-start, the combustion is stopped again. The processing control portion 21 of the controller 20 controls supply of the fuel from the fuel supply portion 8 to the combustor 12, thereby controlling the stop and the-re-start of combustion (step S10).

The stop and the re-start of the combustion are performed predetermined number of times. The predetermined number of times is one or more and is preferably set according to heat transfer state depending on the positional relationship between the reforming catalyst layer 5 and the water evaporator 4 or the configuration of the combustion gas passages b1 and b2. After the stop and the re-start of combustion have been performed predetermined number of times, the reforming catalyst layer 5 is heated to be higher than the third reference temperature T3 (step S11), and the resulting temperature is compared to the second reference temperature T2 as described above (step S3).

By controlling the combustor 12 based on the third and fourth reference temperatures T3 and T4 for adjusting the heating calories for heating the reforming catalyst layer 5, the temperature of the water evaporator 4 is increased acceleratively while keeping down the temperature of the reforming catalyst layer 5 at not higher than 500° C.

While the third reference temperature T3 is set to 250° C. and the fourth reference temperature T4 is set to 200° C., they are not intended to be limited to these but may be other suitable ones so long as the third and fourth reference temperatures T3 and T4 are between the first and second reference temperatures T1 and T2 and the temperature of the water evaporator 4 can be increased acceleratively without increasing the temperature of the reforming catalyst layer 5 up to 500° C. or higher.

With regard to the temperature variation in the reforming catalyst layer 5 after the stop of the combustion in the combustor 12, when the combustor 12 stops combustion at the time point P1 at which the temperature of the reforming catalyst layer 5 reaches the third reference temperature T3, the temperature of the reforming catalyst layer 5 continues to increase for a predetermined time period after the stop since the reforming catalyst layer 5 is heated by overshooting. Then, at the time point P2, the temperature of the reforming catalyst layer 5 reaches its peak which is higher than the third reference temperature T3. In view of such temperature increase caused by the overshooting, it is necessary to set the third reference temperature T3 so that the peak temperature at the time point P2 does not exceed the second reference temperature T2. For example, the third reference temperature T3 is set in a range of 200 to 300° C. After the third reference temperature T3 is decided, the fourth reference temperature T4 may be set between the third reference temperature T3 and the first reference temperature T1.

As should be appreciated from the foregoing, in accordance with the second embodiment, since the heating calories of the reforming catalyst layer 5 can be controlled by controlling the combustion in the combustor 12, the effects described in the first embodiment are enhanced. Consequently, higher reliability is achieved.

In the second embodiment, the stop and the re-start of combustion in the combustor 12 is performed predetermined times, and after that, determination process is performed based on the second reference temperature T2. Alternatively, a time period for which the heating operation involving the stop and re-start of the combustion is performed may be set instead of the number of times. For example, the time period for which the heating operation involving the stop and the re-start of combustion is performed may be preset to 10 minutes. During this time period, the stop and the re-start of the combustion are carried out based on the third and fourth reference temperatures T3 and T4, and after an elapse of 10 minutes, the reforming catalyst layer 5 may be heated up to be higher than the third reference temperature T3. Against the event that the flame will vanish in the combustor 12 after an elapse of 10 minutes and the temperature of the reforming catalyst layer 5 thereby decreases, the combustor 12 may be configured to re-start combustion when the temperature of the reforming catalyst layer 5 reaches the fourth reference temperature T4.

While the water evaporator 4 is heated efficiently while adjusting the heating calories to heat the reforming catalyst layer 5 by repeating the stop and the re-start of the combustion in the combustor 12, switching between a high-calorie heating condition and a low-calorie heating condition in the combustor 12 may alternatively be performed predetermined number of times without the stop. In that case, similar effects are obtained, although it is necessary to approximately set the third and fourth reference temperatures T3 and T4. For example, the amount of the combustion fuel supplied to the combustor 12 may be adjusted so that the ratio of the high calories to the low calories is about 1.5 times.

In another alternative, as will be described later in detail, the low-calorie heating in the combustor 12 may be achieved by increasing the amount of air with respect to the amount of the combustion fuel to lower the temperature of the flame, as compared to normal combustion.

### Embodiment 3

The construction of a hydrogen generator according to a third embodiment of the present invention is substantially identical to that of the first embodiment, and will not be further described. The combustion in the combustor 12 is controlled to adjust the heating calories of the reforming catalyst layer 5 as in the case of the second embodiment, but the following respects are different from those of the second embodiment.

In the second embodiment, the stop and the re-start of the combustion in the combustor 12 are controlled based on the third and fourth reference temperatures T3 and T4, while in the third embodiment, the number of times and the timings of the stop and the re-start of combustion are automatically preset according to the temperature of the reforming catalyst layer 5 at the start of the start-up operation of the hydrogen generator, and based on this setting, the stop and the re-start of the combustion are carried out. The number of times and the timings are set so that the water evaporator 4 is increased acceleratively while keeping down the temperature of the reforming catalyst 5 at lower than 500° C., as in the case of the second embodiment. For example, data indicating the correlation between the number of times and timings of the stop and the re-start of the combustion and temperature variations in the reforming catalyst layer 5 and the water evaporator 4 is stored in the storage portion 24 of the controller 20, and according to the temperature information of the reforming catalyst layer 5 which is detected by the sensor 15 and communicated to the processing control portion 21, optimal number of times and timing are selected from the data in the storage portion 24 and set. In this case, if the detected temperature of the reforming catalyst layer 5 is low, the temperature of the water evaporator 4 is estimated to be also low. In this case, the number of times of preheating is increased. On the other hand, if the detected temperature of the reforming catalyst layer 5 is high, the temperature of the water evaporator 4 is estimated to be also high, and the number of times of preheating is decreased. By way of example, when the detected temperature of the reforming catalyst layer 5 at the start of the start-up operation is 80 to 90° C., 60 to 79° C., and 40 to 59° C., respectively with the first reference temperature T1 set to 100° C., the series of operation involving the stop and the re-start of combustion is performed once, twice, and three times, respectively. And, when the detected temperature is lower than the above, the series of operation is performed four times.

As should be appreciated from the foregoing, in accordance with the start-up operation of the third embodiment, it is possible to properly control the number of times the stop and the re-start of the combustion in the combustor 12 are performed depending on the state of the hydrogen generator at the start time of the start-up operation, specifically, the temperature of the reforming catalyst 5. Consequently, the effects as described in the second embodiment are obtained, and in this case, heating is carried out more efficiently.

While in the third embodiment, the number of times of the stop and the re-start are preset, the time period for which the heating process involving the stop and the re-start of combustion is performed may be preset instead of the number of times, as in the alternative configuration of the second embodiment.

### Embodiment 4

FIG. 8 is a cross-sectional view schematically showing a construction of a hydrogen generator according to a fourth embodiment of the present invention.

In the hydrogen generator of the fourth embodiment, the reformer 3 of the hydrogen generator described in the first embodiment (see FIG. 1) is additionally equipped with a water evaporator temperature sensor 16 configured to detect the temperature of the water evaporator 4 and to output a signal (temperature information) to the controller 20.

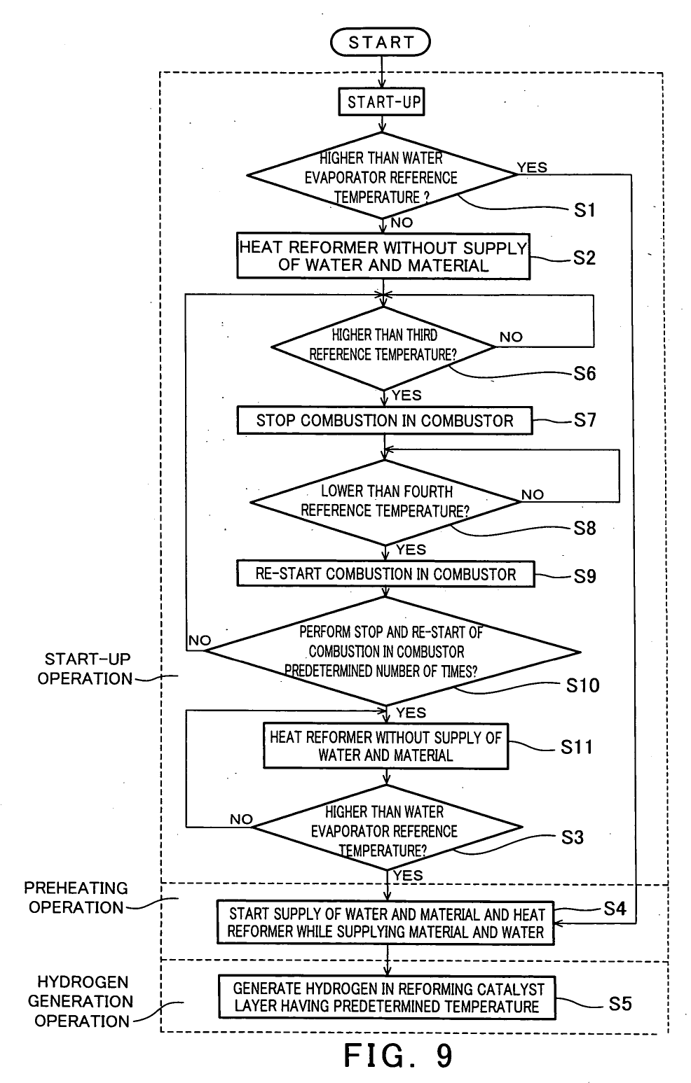

FIG. 9 is a flowchart schematically showing a content of the program stored in the controller 20 of the hydrogen generator of the fourth embodiment.

With reference to the flowchart in FIG. 9, the “first reference temperature” in step S1 and the “second reference temperature” in step S3 in the flowchart in FIG. 5 are respectively represented by “water evaporator reference temperature.”

Specifically, in the fourth embodiment, the temperature of the water evaporator 4 is not predicted from the temperature detected by the reforming temperature sensor 15 but directly measured by the water evaporator temperature sensor 16 to directly and accurately detect the state of the water evaporator 4 in steps S1 and S3 in FIG. 9, and based on the detected temperature, it is determined whether or not the water can be supplied to the water evaporator 4 to generate the steam. Therefore, execution of the steps S6 through S10 in FIG. 9 can be decided directly based on the temperature condition of the water evaporator 4 rather than the number of times and timings employed in the third embodiment.

The determination as to the timings of the stop and the re-start of combustion is executed by the controller 20 based on temperature information output from the reforming catalyst temperature sensor 15 as in the third embodiment, thereby inhibiting degradation of the catalyst which may be caused by the temperature increase in the reforming catalyst layer 15.

The water evaporator temperature sensor 16 may be provided at a location where the sensor 16 can detect with high precision, whether or not the water evaporator 4 can generate the steam, for example, the outer surface or the interior of the water evaporator 4. The water evaporator reference temperature at which the water evaporator 4 can generate the steam varies depending on the construction of the water evaporator 4 or the location of the water evaporator temperature sensor 16. For example, the water evaporator temperature may be set in a temperature range of 50 to 150° C., because the temperature of the portion of the water evaporator 4 where water is largely evaporated is 100° C., and water evaporation is appropriately promoted.

The construction of the hydrogen generator of the fourth embodiment is substantially identical to that of the hydrogen generator of the first embodiment, except addition of the water evaporator temperature sensor 16, and the construction common to both of them will be omitted.

In addition, the operation of the fourth embodiment is substantially identical to that of the second embodiment (FIG. 6) except steps S1 and S3 in FIG. 9, and the operation common to both of them will also be omitted.

### Embodiment 5

The construction of a hydrogen generator according to a fifth embodiment of the present invention is substantially identical to that of the first embodiment, and will not be further described. In the fifth embodiment, the start-up operation is carried out as in the first embodiment. But, in the fifth embodiment, the amount of air supply to the combustor 12 in the combustion of the start-up operation is more than the amount of air supply to the combustor 12 in normal combustion conducted in the preheating operation or the hydrogen generation operation, unlike in the first embodiment, which will be described below.

In the normal combustion, the ratio of theoretical air amount in complete combustion of the combustion fuel supplied from the fuel supply portion 8 to the combustor 12 to the amount of air actually supplied from the air supply portion 7 to the combustor 12 (hereinafter referred to as an air ratio) is set to approximately 1.5. This is because the air ratio in combustion with most desirable combustion characteristics is about 1.5 in the normal combustion, although it may vary depending on the construction of the combustor 12 or combustion method. In this embodiment, the air ratio in the preheating operation and the hydrogen generation operation is set to the air ratio in the normal combustion, i.e., 1.5. On the other hand, in the start-up operation of the fifth embodiment, the air ratio in the combustion is set larger than the air ratio (1.5) in the normal combustion. Specifically, the air ratio in the combustion at the start of the start-up operation is set to not lower than 2.0, for example, in a range of 2.0 to 5.0 where the combustion characteristics will not degrade. In the fifth embodiment, the air ratio is set to 2.0. The reason for this is as follows.

When the combustion fuel is supplied to the combustor 12 at a constant flow rate, the heating calories produced in the combustor 12 is constant. In this state, the temperature of the flame generated within the radiation tube 13 of the combustor 12 varies according to a variation in the amount of air supplied from the air supply portion 7 to the combustor 12. If the air ratio is set larger than the air ratio (1.5) in the normal combustion to increase the amount of air than that in the normal combustion, a combustion exhaust gas resulting from the combustion increases, thereby causing the temperature of the flame to decrease. In the fifth embodiment, the temperature of outer portion of the flame is assumed to be the temperature of the flame. When the controller 20 controls the air supply portion 7 to adjust the amount of air supply so that the air ratio at the start of the start-up operation becomes 2.0, the air more than that in the normal combustion is supplied to the combustor 12 and combusted therein. As a result, the temperature of the flame generated at the start-up operation becomes lower than the temperature of the flame in the normal combustion generated during the preheating operation and the hydrogen generation operation. With the decrease in the temperature of the flame, the temperature of the combustion exhaust gas introduced from the combustor 12 into the combustion gas passage b2 becomes lower than that in the normal combustion. For this reason, during the start-up operation, the difference in temperature between the reforming catalyst layer 5 to be heated and the combustion exhaust gas as a heat source becomes lower, and hence, the calories to be transferred from the combustion exhaust gas to the reforming catalyst layer 5 decreases as compared to those in the preheating operation and the hydrogen generation operation. Since the amount of heat transfer to the reforming catalyst layer 5 decreases, the combustion exhaust gas which has gone through heat exchange with the reforming catalyst layer 5 and is flowing within the combustion gas passage b1 has more calories.

The combustion exhaust gas which has gone through the heat exchange with the reforming catalyst layer 5 flows within the combustion gas passage b1 and is taken out from the reformer 3. While flowing through the combustion gas passage b1, the heat of the combustion exhaust gas is transferred to the water evaporator 4 by heat exchange with the water evaporator 4. Since the combustion exhaust gas which exchanges heat with the water evaporator 4 has more calories in the start-up operation with the air ratio set to 2.0 than in the normal combustion with the air ratio set to 1.5 as described above, the temperature difference between the water evaporator 4 and the combustion exhaust gas becomes large, and thereby the calories transferred to the water evaporator 4 with the air ratio set to 2.0 becomes more than those with the air ration set to 1.5. Therefore, by setting the air ratio of the combustion at the start-up operation to 2.0 higher than that in the normal combustion, the water evaporator 4 is heated acceleratively while inhibiting excessive temperature increase in the reforming catalyst layer 5. Consequently, the start time can be reduced and highly reliable hydrogen generator is achieved.

It will be appreciated that the water evaporator 4 can be heated acceleratively while inhibiting the excessive temperature increase in the reforming catalyst layer 5 more effectively by setting the amount of the combustion fuel supplied to the combustor 12 smaller than the amount of the combustion fuel in the normal combustion, or by increasing the air ratio.

While the start-up operation of the fifth embodiment is substantially identical to that of the start-up operation of the first embodiment except that the air ratio in the start-up operation is higher than that in the normal combustion, it may alternatively be substantially identical to those of the second and third embodiments.

In that case, as described previously, when the combustion in the combustor 12 is stopped, cooling air is supplied from the air supply portion 7 to the combustor 12 to cool the reforming catalyst layer 5. By supplying the cooling air, the heat of the reformer 3 is transferred through the air to the water evaporator 4 located downstream of the reforming catalyst layer 5 in the air flow. Since the supplied air is more than normal in the fifth embodiment, the amount of heat transfer to the water evaporator 4 suitably increases. Consequently, the above described effects are enhanced.

### Embodiment 6

The construction of a hydrogen generator according to a sixth embodiment of the present invention is substantially identical to that of the first embodiment, and will not be further described. The operation of the sixth embodiment is substantially identical to that of the first embodiment except that transition from the start-up operation to the preheating operation is different from that of the first embodiment, which will be described below.

While in the first embodiment, the water and the material are supplied to the reformer 3 when the preheating operation starts, the water is first supplied to the reformer 3 and the material is then supplied to the reformer 3 in the sixth embodiment. Specifically, in the sixth embodiment, at the start-up operation, when it is determined that the temperature of the reforming catalyst layer 5 is higher than the first reference temperature T1 (step S1 in FIG. 3) or higher than the second reference temperature T2 (step S3 in FIG. 3), the water is supplied from the water supply portion 2 to the reforming material passage a of the reformer 3 and the start-up operation transitions to the preheating operation. At this time, the material is not yet supplied from the material supply portion 1 to the reformer 3. The water is evaporated into the steam in the water evaporator 4, and the steam is supplied to the reforming catalyst layer 5 and the reformed gas passage c and flows therethrough. Gases, for example, the gases generated in a previous operation of the hydrogen generator or the air entered after the stop of the operation, may possibly exist within the reforming material passage a, the reformed catalyst layer 5, and the reformed gas passage c. If the reforming catalyst layer 5 is heated up to a high temperature by the preheating operation under the presence of these gases, the reforming catalyst may be oxidized and degrade its catalytic activity, and the material may also be oxidized. It is therefore desirable to drive these gases out from the interior of the body 50 of the reformer 3 in order to improve reliability of the hydrogen generator.

Accordingly, in the sixth embodiment, when it is determined in step S1 and S3 that the temperature of the reforming catalyst 5 have reached the first reference temperature T1 and the second reference temperature T2, the water is supplied to the reformer 3 to generate the steam before the material is supplied to the reformer 3, and the steam is flowed through the reforming material passage a, the reforming catalyst layer 5 and the reformed gas passage c to purge the gases from the interiors thereof. After the purging using the steam for a predetermined time when the preheating operation starts, the material starts to be supplied from the material supply portion 1 to the reformer 3. The time required for the purging means the time required for purging the gases from the entire passages formed within the hydrogen generator, for example, the passages formed within the reformer 3, including the reforming material passage a, the reforming catalyst layer 5 and the reformed gas passage c. For example, when the total volume of the passages formed within the hydrogen generator is 1 L, and the water is supplied to the reformer 3 of the hydrogen generator at a flow rate of 18 g/min, the steam is generated at flow rate of 22.4 L/min, and therefore, the time required for the purging (time for which only the water is supplied in the preheating operation) is 1/22.4 min. Actually, considering safety coefficient, the time twice or three times as long as 1/22.4 min is set as the purge time.

As should be appreciated, in accordance with the sixth embodiment, since the purging is performed using the steam before the material is supplied to the reformer 3, a highly reliable hydrogen generator can be achieved. Although it is necessary to supply an inert gas such as nitrogen from supply means provided independently of the hydrogen generator, as the purge gas in the purging conventionally performed, the supply means of the purge gas may be omitted because the steam generated in the water evaporator 4 is used for the purging. Therefore, the purging is easily performed merely by adjusting the timings at which the water and the material are supplied at the start of the preheating operation.

While the sixth embodiment is substantially identical to the first embodiment except that the purging is performed using the steam generated in the water evaporator 4 as the purge gas, it may alternatively be substantially identical to operations of the second, third, fourth, and the fifth embodiments.

### Embodiment 7

The construction of a hydrogen generator according to a seventh embodiment of the present invention is substantially identical to that of the first embodiment, and will not be further described.

In the seventh embodiment, as in the sixth embodiment, the water is supplied to the reformer 3 before the material is supplied to the reformer 3 and the steam generated from the water is used to purge the gases from the reformer 3. But, instead of starting water supply when the temperature of the water evaporator 4 becomes high enough to generate the steam as in the sixth embodiment, the water is supplied to the water evaporator 4 before the water evaporator 4 is heated up to the temperature at which the water evaporator 4 can generate the steam, and using the saturated steam, the purging is performed, which will be described in detail.

In the first to sixth embodiments, the water starts to be supplied to the reformer 3 in the transition from the start-up operation to the preheating operation, whereas in the seventh embodiment, the water starts to be evaporated in the water evaporator 4 in the transition from the start-up operation to the preheating operation. In the seventh embodiment, the operation for heating the water evaporator 4 which contains the supplied water up to the temperature at which the water evaporator 4 can generate the steam is defined as the start-up operation, and the operation performed from when the steam starts to be generated until the reforming reaction is performed is defined as the preheating operation.

In the seventh embodiment, a predetermined amount of water is supplied from the water supply portion 2 to the reformer 3 and reserved in the water evaporator 4 irrespective of the temperatures of the reforming catalyst layer 5 and the water evaporator 4 at the start of the start-up operation of the hydrogen generator. When the temperature of the reforming catalyst layer 5 at the start of the start-up operation of the hydrogen generator is lower than the first reference temperature T1, the water reserved in the water evaporator 4 is not evaporated just after the start-up operation starts. But, as the temperature of the water evaporator 4 increases gradually by the heating by the combustion in the combustor 12, the water evaporator 4 generates the saturated steam according to the temperature. In the seventh embodiment, using the saturated steam, the purging of the reformer 3 is carried out. On the other hand, when it is determined that the temperature of the reforming catalyst layer 5 at the start of the start-up operation is higher than the first reference temperature T1 (step S3 in FIG. 3), and it is determined that the temperature of the reforming catalyst layer 5 being heated while performing the purging using the steam becomes higher than the second reference temperature T2 (step S3 in FIG. 3), the water evaporator 4 can generate the steam, and the water reserved in the water evaporator 4 is evaporated into the steam, which is supplied to the reforming catalyst layer 5. Thus, the start-up operation transitions to the preheating operation. Upon the start of the preheating operation, the water is supplied from the water supply portion 1 to the reformer 3, and the material is supplied from the material supply portion 2 to the reformer 3 after an elapse of time after the start of water supply. Thereby, as in the sixth embodiment, the gases are purged from the reformer 3 by using the steam as the purge gas.

As should be appreciated from the foregoing, in accordance with the seventh embodiment, as in the sixth embodiment, the purging of the reformer 3 can be performed using the steam, the effects of the sixth embodiment are obtained. In addition, when the temperature of the reforming catalyst layer 5 at the start time of the start-up operation of the hydrogen generator is lower than the first reference temperature T1, and the reforming catalyst layer 5, the water evaporator 4, and the passages within the reformer 3 do not increase in temperature, the gases are purged from the reformer 3 as desired using the saturated steam of the water reserved in the water evaporator 4. As a result, the substance removing ability by the purging is improved, and the time required for the purging at the start of the preheating operation can be reduced.

The construction and operation of the hydrogen generator of the present invention are not intended to be limited to those of the first through sixth embodiments. While the reformer 3 is heated by the combustion in the combustor 12 in the first through sixth embodiments, it may alternatively be heated by an electric heater or heating means using a high-temperature inert gas. In addition, while the construction of the reformer 3 of the hydrogen generator has been in large part described in the first through sixth embodiments, the hydrogen generator may suitably be equipped with a treating portion other than the reformer 3. As will be described later in the eighth embodiment, the hydrogen generator employed in the fuel cell system is equipped with a CO shifter and a CO selective oxidization portion configured to treat the reformed gas generated in the reformer 3.

### Embodiment 8

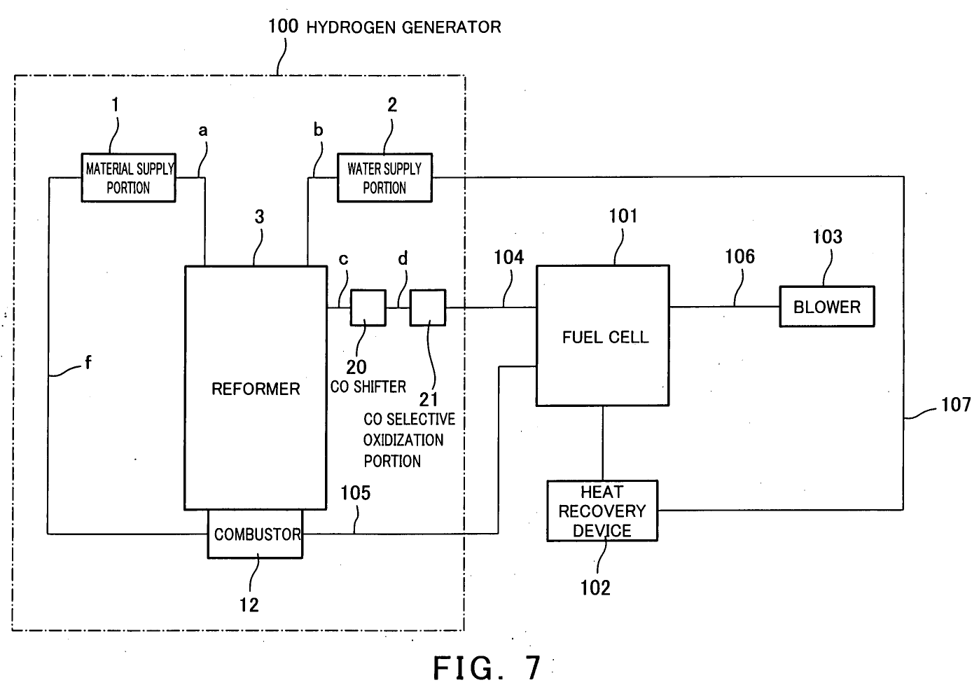

FIG. 7 is a block diagram schematically showing a construction of a fuel cell system according to an eighth embodiment of the present invention. The fuel cell system comprises, as major components, a hydrogen generator 100, a fuel cell 101, a heat recovery device 102, and a blower 103. The fuel cell 101 is, for example, a polymer electrolyte fuel cell.

The hydrogen generator 100 may be a hydrogen generator of any one of the first through seventh embodiments, and further includes a CO shifter 20 and a CO selective oxidization portion 21. Specifically, the reformed gas passage c of the reformer 3 in FIG. 1 is connected to the CO shifter 20, which is in turn connected to the CO selective oxidization portion 21 through a shifted gas passage d. In the hydrogen generator 100 thus constructed, the reformed gas generated in the reformed catalyst layer 5 is supplied to the CO shifter 20 through the reformed gas passage c and CO concentration is reduced therein. The resulting shifted gas is supplied from the CO shifter 20 to the selective oxidization portion 21 through the shifted gas passage d, and the CO concentration is further reduced therein. Though the CO reduction process performed in the CO shifter 20 and the CO selective oxidization portion 20, a hydrogen-rich gas (hydrogen) with a low CO concentration is gained in the hydrogen generator 100.

In the fuel cell system, the hydrogen generator 100 is connected to the fuel cell 101 through a power generation fuel pipe 104 and a fuel off gas pipe 105. The fuel cell 101 is connected to the blower 103 through an air pipe 106. The heat recovery device 102 is capable of recovering the heat generated during power generation in the fuel cell 101. The heat recovery device 102 is comprised of a hot water generator equipped with a tank, and is configured to recovery the heat generated during power generation in the fuel cell 101 to generate the hot water by heat exchange with the water within the tank. Although not shown, the fuel cell system is configured to supply electric power obtained by the power generation to an electric power load terminal, and to supply the heat recovered by the heat recovery device 102 to a thermal load terminal.

In a cogeneration operation of the fuel cell system, first, the start-up operation, the preheating operation, and the hydrogen generation operation are carried out in the hydrogen generator 100 as described previously. These operations are identical to those of the first through seventh embodiments, and will not be further described. As previously described in the first through seventh embodiments, the hydrogen generator 100 can reduce the time required for the start-up operation and achieve the highly reliable operation.

Hydrogen generated in the hydrogen generator 100 is supplied to an anode of the fuel cell 101 as a power generation fuel through the power generation fuel pipe 104, while air is supplied from the blower 103 to a cathode of the fuel cell 101 through the air pipe 106. In the fuel cell 101, the hydrogen and the air react to generate the electric power (hereinafter referred to as power generation reaction), and heat is also generated through the power generation reaction. The electric power generated through the power generation reaction is supplied to and consumed in the electric power load terminal (not shown), while the heat generated through the power generation reaction is recovered by the heat recovery device 102, and thereafter supplied to the thermal load terminal (not shown) and consumed for various uses. Hydrogen (fuel off gas) unconsumed in the power generation reaction is recovered from the fuel cell 101 and supplied to the combustor 12 of the hydrogen generator 100 through the fuel off gas pipe 105.

In the fuel cell system of the eighth embodiment, hydrogen can be generated in the hydrogen generator 100 with high reliability, and supplied stably to the fuel cell 101. Therefore, the fuel cell 101 can generate electric energy and heat energy efficiently and stably. Consequently, an energy-saving and economical cogeneration system is achieved.

It will be appreciated that, while the hydrogen generator of the present invention is employed in the fuel cell system in the eighth embodiment, it may be applicable to systems other than the fuel cell system.

Numerous modifications and alternative embodiments of the invention will be apparent to those skilled in the art in the light of the foregoing description. Accordingly, the description is to be construed as illustrative only, and is provided for the purpose of teaching those skilled in the art the best mode of carrying out the invention. The details of the structure and/or function may be varied substantially without departing from the spirit of the invention.

1. A hydrogen generator comprising:
a reformer configured to conduct reforming reaction using a material containing an organic compound comprised of at least carbon atoms and hydrogen atoms, steam, and a reforming catalyst, to generate hydrogen;
a material supply portion configured to supply the material to said reformer;
a water supply portion configured to supply water to said reformer,
a heater configured to heat said reformer; and
a controller configured to control supply of the material from said material supply portion and supply of the water from said water supply portion, wherein
said reformer includes a water evaporator configured to evaporate the water supplied from said water supply portion, a reforming catalyst layer formed by the reforming catalyst, and a reforming temperature sensor configured to detect a temperature of said reforming catalyst layer,
said controller includes a determination portion configured to determine whether or not said water evaporator has a temperature at which said water evaporator can generate the steam based on the temperature of said reforming catalyst layer detected by said reforming temperature sensor, and a supply control portion configured to control at least the supply of the water from said water supply portion to said reformer based on determination of said determination portion,
said determination portion is configured to perform a first determination process in such a manner that said determination portion compares the temperature of said reforming catalyst layer detected when said heater starts heating of said reformer to start a start-up operation of the hydrogen generator to a first reference temperature,
said determination portion is configured to perform a second determination process in such a manner that said determination portion compares the temperature of said reforming catalyst layer which is detected while said reformer is heated after said first determination process to a second reference temperature which is higher than said first reference temperature, when said determination portion determines that the temperature of said reforming catalyst layer is not higher than said first reference temperature in said first determination process, and
said supply control portion is configured to start the supply of the water to said reformer when said determination portion determines that the temperature of said reforming catalyst layer is higher than said first reference temperature in said first determination process or when said determination portion determines that the temperature of said reforming catalyst layer is higher than said second reference temperature in said second determination process.

2. The hydrogen generator according to claim 1, wherein said second reference temperature is set so that catalytic activity of said reforming catalyst layer is not degraded under absence of the steam.

3. The hydrogen generator according to claim 1, wherein said first reference temperature is not lower than 50° C. and not higher than 150° C., and said second reference temperature is not lower than 300° C. and not higher than 500° C.

4. The hydrogen generator according to claim 1, wherein said reformer further includes a water evaporator temperature sensor configured to detect a temperature of said water evaporator,
said controller includes a determination portion configured to determine whether or not said water evaporator has a temperature at which said water evaporator can generate the steam based on the temperature of said water evaporator detected by said water evaporator temperature sensor at the start of the start-up operation of said hydrogen generator, and a supply control portion configured to control at least the supply of the water from said water supply portion to said reformer based on determination of said determination portion,
said supply control portion is configured to start the supply of the water when said determination portion determines that the temperature of said water evaporator is higher than a water evaporator reference temperature at which said water evaporator can generate the steam in determination of said determination portion, and
said heater is configured to heat said reformer when said determination portion determines that the temperature of said water evaporator is not higher than said water evaporator reference temperature, and said supply control portion is configured to start the supply of the water when said determination portion determines that the temperature of said water evaporator is higher than said water evaporator reference temperature.

5. A hydrogen generator comprising:
a reformer configured to conduct reforming reaction using a material containing an organic compound comprised of at least carbon atoms and hydrogen atoms, steam, and a reforming catalyst, to generate hydrogen;
a material supply portion configured to supply the material to said reformer;
a water supply portion configured to supply water to said reformer,
a heater configured to heat said reformer; and
a controller configured to control supply of the material from said material supply portion and the supply of the water from said water supply portion, wherein
said reformer includes a water evaporator configured to evaporate the water supplied from said water supply portion, a reforming catalyst layer formed by the reforming catalyst, and a reforming temperature sensor configured to detect a temperature of said reforming catalyst layer,
said controller includes a determination portion configured to determine whether or not said water evaporator has a temperature at which said water evaporator can generate the steam based on the temperature of said reforming catalyst layer detected by said reforming temperature sensor, and a supply control portion configured to control at least the supply of the water from said water supply portion to said reformer based on determination of said determination portion,
said determination portion is configured to perform a first determination process in such a manner that said determination portion compares the temperature of said reforming catalyst layer detected when said heater starts heating of said reformer to start a start-up operation of said hydrogen generator to a first reference temperature,
said determination portion is configured to perform a second determination process in such a manner that said determination portion compares the temperature of said reforming catalyst layer which is detected while said reformer is heated after said first determination process to a second reference temperature which is higher than said first reference temperature, when said determination portions determines that the temperature of said reforming catalyst layer is not higher than said first reference temperature in said first determination process,
said determination portion is configured to start a third determination process in such a manner that said determination portion compares the temperature of said reforming catalyst layer which is detected while said reformer is heated after said first determination process to a third reference temperature which is higher than said first reference temperature and lower than said second reference temperature, when said determination portion determines that the temperature of said reforming catalyst layer is not higher than said first reference temperature in said first determination process, and
said heater is configured to stop the heating of said reformer when said determination portion determines that the temperature of said reforming catalyst layer is higher than said third reference temperature in said third determination process, and said determination portion is configured to perform a fourth determination process in such a manner that said determination portion compares the temperature of said reforming catalyst layer after the stop of the heating to a fourth reference temperature which is lower than said third reference temperature and higher than said first reference temperature, and
said heater is configured to re-start the heating of said reformer when said determination portion determines that the temperature of said reforming catalyst layer is lower than said fourth reference temperature in said fourth determination process.

6. The hydrogen generator according to claim 5, wherein said third reference temperature is not lower than 200° C. and not higher than 300° C.

7. The hydrogen generator according to claim 6, wherein said heater is configured to heat said reformer so that the temperature of said reforming catalyst layer becomes higher than said third reference temperature, after stop and re-start of the heating of said reformer is performed at least once, or after the heating of said reformer involving the stop and the re-start is performed for a predetermined time period, and said supply control portion is configured to start the supply of the water when said determination portion determines that the temperature of said reforming catalyst layer is higher than said second reference temperature in said second determination process.

8. The hydrogen generator according to claim 7, wherein said controller is configured to decide the number of times the stop and the re-start of the heating are performed or the time period for which the heating involving the stop and the re-start is performed, according to the temperature of said reforming catalyst layer detected at the start of the start-up operation of said hydrogen generator.

9. The hydrogen generator according to claim 8, wherein
said reformer further includes a water evaporator temperature sensor configured to detect a temperature of said water evaporator,
said controller includes a determination portion configured to determine whether or not said water evaporator has a temperature at which said water evaporator can generate the steam based on the temperature of said water evaporator detected by said water evaporator temperature sensor, and a supply control portion configured to control at least the supply of the water from said water supply portion based on determination of said determination portion,
said heater is configured to heat said reformer when said determination portion determines that the temperature of said water evaporator is not higher than said water evaporator reference temperature at which said water evaporator can generate the steam in determination of said determination portion,
said heater is configured to stop the heating of said reformer when said determination portion determines that the temperature of said reforming catalyst layer reaches said third reference temperature,
said heater is configured to re-start the heating of said reformer when said determination portion determines that the temperature of said reforming catalyst layer reaches said fourth reference temperature after the stop of the heating, and said supply control portion is configured to start the supply of the water when said determination portion determines that the temperature of said water evaporator is higher than said water evaporator reference temperature, based on a signal output from said water evaporator temperature sensor.

10. The hydrogen generator according to claim 9, wherein said water evaporator reference temperature is not lower than 50° C. and not higher than 150° C.

11. The hydrogen generator according to claim 1, wherein said water evaporator is located at an outermost portion of said reformer, and said reforming catalyst layer is located inward relative to said water evaporator.

12. The hydrogen generator according to claim 5, wherein said water evaporator is located at an outermost portion of said reformer, and said reforming catalyst layer is located inward relative to said water evaporator.

13. The hydrogen generator according to claim 1, wherein said heater includes a burner configured to combust a combustion fuel and air, a fuel supply portion configured to supply the combustion fuel to said burner, and an air supply portion configured to supply the air to said burner, wherein
said reformer is configured to exchange heat between a combustion exhaust gas generated in said burner and said reforming catalyst layer and then between the combustion exhaust gas and said water evaporator.

14. The hydrogen generator according to claim 5, wherein said heater includes a burner configured to combust a combustion fuel and air, a fuel supply portion configured to supply the combustion fuel to said burner, and an air supply portion configured to supply the air to said burner, wherein
said reformer is configured to exchange heat between a combustion exhaust gas generated in said burner and said reforming catalyst layer and then between the combustion exhaust gas and said water evaporator.

15. The hydrogen generator according to claim 1, wherein
said supply control portion is configured to control supply of the air from said air supply portion to a burner of said heater,
said air supply portion is configured to supply the air to said burner at a first flow rate after said water supply portion starts the supply of the water,
said air supply portion is configured to supply the air to said burner at a second flow rate when said determination portion determines that the temperature of said reforming catalyst layer is not higher than said first reference temperature in said first determination process, and
a ratio of the first flow rate to a theoretical air amount in complete combustion of the combustion fuel in combustion performed with the air supplied at the first flow rate is smaller than a ratio of a second flow rate to the theoretical air amount in complete combustion of the combustion fuel in combustion performed with the air supplied at the second flow rate.

16. The hydrogen generator according to claim 5, wherein
said supply control portion is configured to control supply of the air from said air supply portion to a burner of said heater,
said air supply portion is configured to supply the air to said burner at a first flow rate after said water supply portion starts the supply of the water,
said air supply portion is configured to supply the air to said burner at a second flow rate when said determination portion determines that the temperature of said reforming catalyst layer is not higher than said first reference temperature in said first determination process, and
a ratio of the first flow rate to a theoretical air amount in complete combustion of the combustion fuel in combustion performed with the air supplied at the first flow rate is smaller than a ratio of a second flow rate to the theoretical air amount in complete combustion of the combustion fuel in combustion performed with the air supplied at the second flow rate.

17. The hydrogen generator according to claim 15, wherein the ratio of the second flow rate to the theoretical air amount in the complete combustion of the combustion fuel in the combustion performed with the air supplied at the second flow rate is not lower than 2.0.

18. The hydrogen generator according to claim 16, wherein the ratio of second flow rate to the theoretical air amount in the complete combustion of the combustion fuel in the combustion performed with the air supplied at the second flow rate is not lower than 2.0.

19. The hydrogen generator according to claim 5, wherein said supply control portion is configured to inject the air from said air supply portion to a burner of said heater in a heating stop period during which the combustion in said burner is stopped according to determination of said third determination process.

20. The hydrogen generator according to claim 1, wherein said supply control portion is configured to start the supply of the material from said material supply portion after an elapse of a predetermined time after the start of the water supply according to determination in said first determination process or after an elapse of a predetermined time after the start of the water supply according to determination in said second determination process.

21. The hydrogen generator according to claim 5, wherein said supply control portion is configured to start the supply of the material from said material supply portion after an elapse of a predetermined time after the start of the water supply according to determination in said first determination process or after an elapse of a predetermined time after the start of the water supply according to determination in said second determination process.

22. The hydrogen generator according to claim 1, wherein the water is reserved in said water evaporator before the temperature of said water evaporator becomes a temperature at which said water evaporator can generate the steam.

23. The hydrogen generator according to claim 5, wherein the water is reserved in said water evaporator before the temperature of said water evaporator becomes a temperature at which said water evaporator can generate the steam.

24. A method of operating a hydrogen generator including:
a reformer configured to conduct reforming reaction using a material containing an organic compound comprised of at least carbon atoms and hydrogen atoms, steam, and a reforming catalyst, to generate hydrogen;
a material supply portion configured to supply the material to said reformer;
a water supply portion configured to supply water to said reformer,
a heater configured to heat said reformer; and
a controller configured to control supply of the material from said material supply portion and supply of the water from said water supply portion, wherein
said reformer includes a water evaporator configured to evaporate the water supplied from said water supply portion, a reforming catalyst layer formed by the reforming catalyst, and a reforming temperature sensor configured to detect a temperature of said reforming catalyst layer,
said method comprising the steps of:
performing a first determination process in such a manner that said controller compares the temperature of said reforming catalyst layer detected when said heater starts heating of said reformer to start a start-up operation of the hydrogen generator to a first reference temperature;
performing a second determination process in such a manner that said controller compares the temperature of said reforming catalyst layer which is detected while said reformer is heated after said first determination process to a second reference temperature which is higher than said first reference temperature, when it is determined that the temperature of said reforming catalyst layer is not higher than said first reference temperature in said first determination process; and
starting the supply of the water from said water supply portion to said reformer when it is determined that the temperature of said reforming catalyst layer is higher than said first reference temperature in said first determination process or when it is determined that the temperature of said reforming catalyst layer is higher than said second reference temperature in said second determination process.

25. The method according to claim 24, wherein
said reformer further includes a water evaporator temperature sensor configured to detect a temperature of said water evaporator, said method further comprising the steps of:
starting the supply of the water when it is determined that the temperature of said water evaporator detected by said water evaporator temperature sensor is higher than a water evaporator reference temperature at which said water evaporator can generate the steam; and
heating said reformer when it is determined that the temperature of said water evaporator is not higher than said water evaporator reference temperature, and starting the supply of the water when it is determined that the temperature of said water evaporator is higher than said water evaporator reference temperature.

26. A method of operating a hydrogen generator including:
a reformer configured to conduct reforming reaction using a material containing an organic compound comprised of at least carbon atoms and hydrogen atoms, steam, and a reforming catalyst, to generate hydrogen;
a material supply portion configured to supply the material to said reformer;
a water supply portion configured to supply water to said reformer,
a heater configured to heat said reformer; and
a controller configured to control the supply of the material from said material supply portion and the supply of the water from said water supply portion, wherein
said reformer includes a water evaporator configured to evaporate the water supplied from said water supply portion, a reforming catalyst layer formed by the reforming catalyst, and a reforming temperature sensor configured to detect a temperature of said reforming catalyst layer, said method comprising the steps of:
performing a first determination process in such a manner that said controller compares the temperature of said reforming catalyst layer detected when said heater starts heating of said reformer to start a start-up operation of said hydrogen generator to a first reference temperature;
performing a second determination process in such a manner that said controller compares the temperature of said reforming catalyst layer which is detected while said reformer is heated after said first determination process to a second reference temperature which is higher than said first reference temperature, when it is determined that the temperature of said reforming catalyst layer is not higher than said first reference temperature in said first determination process;
performing a third determination process in such a manner that said controller compares the temperature of said reforming catalyst layer which is detected while said reformer is heated after said first determination process to a third reference temperature which is higher than said first reference temperature and lower than said second reference temperature, when it is determined that the temperature of the reforming catalyst layer is not higher than said first reference temperature in said first determination process; and
stopping the heating of said reformer when it is determined that the temperature of said reforming catalyst layer is higher than said third reference temperature in said third determination process; and
performing a fourth determination process in such a manner that said controller compares the temperature of said reforming catalyst layer after the stop of the heating to a fourth reference temperature which is lower than said third reference temperature and higher than said first reference temperature; and
re-starting the heating of said reformer when it is determined that the temperature of said reforming catalyst layer is lower than said fourth reference temperature in said fourth determination process.

27. The method according to claim 26, further comprising:
deciding the number of times stop and re-start of the heating of said reformer are performed or a time period for which the heating of said reformer involving the stop and the re-start is performed, according to the temperature of said reforming catalyst layer detected at the start of the start-up operation of said hydrogen generator;
performing the heating involving the stop and the re-start of the heating of said reformer the decided number of times or for the decided time period;
performing the heating so that said reforming catalyst layer becomes higher than said third reference temperature; and
starting the supply of the water from said water supply portion to said reformer when it is determined that the temperature of said reforming catalyst layer is higher than said second reference temperature in said second determination process.

28. The method according to claim 27, wherein said reformer further includes a water evaporator temperature sensor configured to detect a temperature of said water evaporator, said method further comprising the steps of:
heating said reformer when it is determined that the temperature of said water evaporator detected by said water evaporator temperature sensor is not higher than a water evaporator reference temperature at which said water evaporator can generate the steam;
stopping the heating of said reformer when it is determined that the temperature of said reforming catalyst layer is higher than said third reference temperature;
re-starting the heating of said reformer when it is determined that the temperature of said reforming catalyst layer after the stop of the heating is lower than said fourth reference temperature; and
starting the supply of the water when it is determined that the temperature of said water evaporator is higher than said water evaporator reference temperature based on a signal output from said water evaporator temperature sensor.

29. The method according to claim 24, wherein
said heater includes a burner configured to combust a combustion fuel and air, a fuel supply portion configured to supply the combustion fuel to said burner, and an air supply portion configured to supply the air from said air supply portion to said burner,
said controller is configured to control said air supply portion,
the air is supplied from said air supply portion to said burner at a first flow rate in the heating after said water supply portion starts the supply of the water,
the air is supplied from said air supply portion to said burner at a second flow rate when it is determined that the temperature of said reforming catalyst layer is not higher than said first reference temperature in said first determination process at the start of the start-up operation of said hydrogen generator, and
a ratio of the first flow rate to a theoretical air amount in complete combustion of the combustion fuel in combustion performed with the air supplied at the first flow rate is smaller than a ratio of the second flow rate to the theoretical air amount in complete combustion of the combustion fuel in combustion performed with the air supplied at the second flow rate.

30. The method according to claim 26, wherein
said heater includes a burner configured to combust a combustion fuel and air, a fuel supply portion configured to supply the combustion fuel to said burner, and an air supply portion configured to supply the air to said burner,
said controller is configured to control said air supply portion,
the air is supplied from said air supply portion to said burner at a first flow rate in the heating after said water supply portion starts supply of the water,
the air is supplied from said air supply portion to said burner at a second flow rate when it is determined that the temperature of said reforming catalyst layer is not higher than said first reference temperature, and
a ratio of the first flow rate to a theoretical air amount in complete combustion of the combustion fuel in combustion performed with the air supplied at the first flow rate is smaller than a ratio of the second flow rate to the theoretical air amount in complete combustion of the combustion fuel in combustion performed with the air supplied at the second flow rate.

31. The method according to claim 26, wherein
said heater includes a burner configured to combust a combustion fuel and air, a fuel supply portion configured to supply the combustion fuel to said burner, and an air supply portion configured to supply the air to said burner, wherein the air is injected from said air supply portion to said burner in a heating stop period during which combustion in said burner is stopped according to determination in said third determination process.

32. The method according to claim 24, further comprising:
starting the supply of the material from said material supply portion to said reformer by said controller after an elapse of a predetermined time after start of the supply of the water after said first determination process or after an elapse of a predetermined time after start of the supply of the water after said second determination process.

33. The method according to claim 26, further comprising:
starting the supply of the material from said material supply portion to said reformer by said controller after an elapse of a predetermined time after start of the supply of the water after said first determination process or after an elapse of a predetermined time after start of the supply of the water after said second determination process.

34. A fuel cell system comprising:
a hydrogen generator;
an air supply device; and
a fuel cell configured to cause hydrogen supplied from said hydrogen generator and air supplied from said air supply device to react to generate electric power, said hydrogen generator including:
a reformer configured to conduct reforming reaction using a material containing an organic compound comprised of at least carbon atoms and hydrogen atoms, steam, and a reforming catalyst, to generate hydrogen;
a material supply portion configured to supply the material to said reformer;
a water supply portion configured to supply water to said reformer,
a heater configured to heat said reformer; and
a controller configured to control supply of the material from said material supply portion and supply of the water from said water supply portion, wherein
said reformer includes a water evaporator configured to evaporate the water supplied from said water supply portion, a reforming catalyst layer formed by the reforming catalyst, and a reforming temperature sensor configured to detect a temperature of said reforming catalyst layer,
said controller includes a determination portion configured to determine whether or not said water evaporator has a temperature at which said water evaporator can generate the steam based on the temperature of said reforming catalyst layer detected by said reforming temperature sensor, and a supply control portion configured to control at least the supply of the water from said water supply portion to said reformer based on determination of said determination portion,
said determination portion is configured to perform a first determination process in such a manner that said determination portion compares the temperature of said reforming catalyst layer detected when said heater starts heating of said reformer to start a start-up operation of said hydrogen generator to a first reference temperature, and
said determination portion is configured to perform a second determination process in such a manner that said determination portion compares the temperature of said reforming catalyst layer which is detected while said reformer is heated after said first determination process to a second reference temperature which is higher than said first reference temperature, when said determination portion determines that the temperature of said reforming catalyst layer is not higher than said first reference temperature in said first determination process,
said supply control portion is configured to start the supply of the water to said reformer when said determination portion determines that that the temperature of said reforming catalyst layer is higher than said first reference temperature in said first determination process or when said determination portion determines that the temperature of said reforming catalyst layer is higher than said second reference temperature in said second determination process.

35. A fuel cell system comprising:
a hydrogen generator;
an air supply device; and
a fuel cell configured to cause hydrogen supplied from said hydrogen generator and air supplied from said air supply device to react to generate electric power, said hydrogen generator including:
a reformer configured to conduct reforming reaction using a material containing an organic compound comprised of at least carbon atoms and hydrogen atoms, steam, and a reforming catalyst, to generate hydrogen;
a material supply portion configured to supply the material to said reformer;
a water supply portion configured to supply water to said reformer,
a heater configured to heat said reformer; and
a controller configured to control supply of the material from said material supply portion and the supply of the water from said water supply portion, wherein
said reformer includes a water evaporator configured to evaporate the water supplied from said water supply portion, a reforming catalyst layer formed by the reforming catalyst, and a reforming temperature sensor configured to detect a temperature of said reforming catalyst layer,
said controller includes a determination portion configured to determine whether or not said water evaporator has a temperature at which said water evaporator can generate the steam based on the temperature of said reforming catalyst layer detected by said reforming temperature sensor, and a supply control portion configured to control at least the supply of the water from said water supply portion to said reformer based on determination of said determination portion,
said determination portion is configured to perform a first determination process in such a manner that said determination portion compares the temperature of said reforming catalyst layer detected when said heater starts the heating of said reformer to start a start-up operation of said hydrogen generator to a first reference temperature,
said determination portion is configured to perform a second determination process in such a manner that said determination portion compares the temperature of said reforming catalyst layer which is detected while said reformer is heated after said first determination process to a second reference temperature which is higher than said first reference temperature, when said determination portion determines that the temperature of said reforming catalyst layer is not higher than said first reference temperature in said first determination process,
said determination portion is configured to perform a third determination process in such a manner that said determination portion compares the temperature of said reforming catalyst layer which is detected while said reformer is heated after said first determination process to a third reference temperature which is higher than said first reference temperature and lower than said second reference temperature, when said determination portion determines that the temperature of the reforming catalyst layer is not higher than said first reference temperature in said first determination process,
said heater is configured to stop the heating of said reformer when said determination portion determines that the temperature of said reforming catalyst layer is higher than said third reference temperature in said third determination process, and said determination portion is configured to perform a fourth determination process in such a manner that said determination portion compares the temperature of said reforming catalyst layer after the stop of the heating to a fourth reference temperature which is lower than said third reference temperature and higher than said first reference temperature, and
said heater is configured to re-start the heating of said reformer when said determination portion determines that the temperature of said reforming catalyst layer is lower than said fourth reference temperature in said fourth determination process.
